(19) United States
(12) Patent Application Publication
(10) Pub. No.: US 2011/0267299 A1
(43) Pub. Date: Nov. 3, 2011

(54) PORTABLE TERMINAL, CONTROL PROGRAM AND CONTROL METHOD

(75) Inventors: Kazuto Miyazaki, Osaka (JP); Takashi Izumi, Osaka (JP)

(73) Assignee: KYOCERA CORPORATION, Kyoto (JP)

(21) Appl. No.: 13/143,169

(22) PCT Filed: Nov. 10, 2010
(86) PCT No.: PCT/JP2010/006613

§ 371 Date: Jul. 1, 2011

(30) Foreign Application Priority Data
Nov. 12, 2009 (JP) 2009-259358

(51) Int. Cl. G06F 3/041

(52) U.S. Cl. 345/173

(57) ABSTRACT

A portable terminal pertaining to the present invention comprises: a touchpad having a plurality of areas; an illumination unit that illuminates the touchpad in lit state, and does not illuminate the touchpad in unlit state; and a control unit that detects contact made to the areas of the touchpad, performs a first judgment when detecting contact made to at least one of the areas of the touchpad while the illumination unit is unlit, the first judgment being a judgment of whether the number of areas of the touchpad to which the contact during the unlit state has been made equals or exceeds a predetermined number within a first interval from the detection of the contact, and turns the illumination unit on when the result of the first judgment is negative and does not turn the illumination unit on when the result of the first judgment is positive.

### TECHNICAL FIELD

The present invention relates to a portable terminal such as a mobile phone having an illumination unit for illuminating a touchpad incorporated therein, and in particular to a technology for controlling turning on/off of the illumination unit according to input from the touchpad.

### BACKGROUND ART

There are some conventional technologies for controlling turning on/off of a backlight provided to an operation unit (Patent Literature 1, for example). In this method, control of the backlight is performed such that the backlight switches between a lit state and an unlit state according to user operations. More specifically, when user operations are not made for a predetermined interval while the backlight is on, the backlight is turned off. Contrariwise, when user operations are made while the backlight is off, the backlight is turned on.

The application of such a technology ensures user visibility of the keys during user operations, while, at the same time, realizing a cut down in electric consumption by turning the backlight off when lighting thereof is unnecessary since no user operations are being made.

### CITATION LIST

### Patent Literature

[Patent Literature 1] Japanese Patent Application Publication No. 11-275202

### SUMMARY OF INVENTION

### Technical Problem

In recent years, there has been a wide spread of portable terminals such as mobile phones which can be operated by using a touchpad. However, problems arise when the backlight control technology as introduced in Patent Literature 1 is applied to such portable terminals. For instance, in cases where a user's body part besides his/her finger contacts the touchpad, or where an object which is disposed in a user's bag along with the portable terminal contacts the touchpad of the portable terminal (such cases are referred to hereinafter as “erroneous contact”), an illumination unit, such as a backlight provided for illuminating the touchpad, is turned on unintentionally, and causes unnecessary electric consumption.

The present invention has been conceived in view of such problems, and a purpose thereof is to provide a portable terminal such as a mobile phone, which reduces the risk of the illumination unit provided thereto being turned on unintentionally as a result of erroneous contact being made, thereby preventing unnecessary consumption of electricity.

### Solution to Problems

In order to solve the above-presented problems, one aspect of the present invention is a portable terminal comprising: a touchpad having a plurality of areas; an illumination unit configured to illuminate the touchpad when in a lit state, and not to illuminate the touchpad when in an unlit state; and a control unit configured to detect contact made to each of the areas of the touchpad, to perform a first judgment when detecting contact made to at least one of the areas of the touchpad during the unlit state of the illumination unit, the first judgment being a judgment of whether or not the number of areas of the touchpad to which the contact during the unlit state of the illumination unit has been made equals or exceeds a predetermined number within a first interval from the detection of the contact during the unlit state of the illumination unit, and to cause the illumination unit to enter the lit state when the result of the first judgment is negative and not to cause the illumination unit to enter the lit state when the result of the first judgment is positive.

Here, the term “contact” not only refers to a state where a user's finger, face, or other body parts, or objects such as a touch pen is put into direct contact with the touchpad. Especially when the touchpad is a capacitive touchpad, the term “contact” also refers to a state where a user's finger, face, or other body parts, or objects such as a touch pen comes in close proximity to the touchpad and thus, changes the electrostatic capacity of the touchpad by a greater degree than a predetermined level of change.

### Advantageous Effects of the Invention

According to the portable terminal of the present invention having the above-presented structure, the risk is reduced of the illumination unit being unintentionally turned on by erroneous contact being made to the touchpad. Furthermore, the risk of unnecessary electric consumption caused by unintentional lighting of the illumination unit is reduced.

### BRIEF DESCRIPTION OF DRAWINGS

FIG. 1 is a perspective view illustrating the exterior appearance of a mobile phone 100 pertaining to embodiment 1 during a closed state thereof.

FIG. 2 is a perspective view illustrating the exterior appearance of the mobile phone 100 pertaining to embodiment 1 during an open state thereof.

FIG. 3 is a front elevational view illustrating the exterior appearance of the mobile phone 100 pertaining to embodiment 1 during a closed state thereof.

FIG. 4 is a block diagram illustrating the functional structure of main components of the mobile phone 100.

FIG. 5 illustrates the changes observed in a key contact value calculated by a calculation unit 111.

FIG. 6 is a flowchart illustrating control processing performed by the mobile phone 100 in response to input from a touchpad 102.

FIG. 7 is a flowchart illustrating key press judgment processing (Step S9 in FIG. 6) performed by the mobile phone 100.

FIG. 8 illustrates an example of an operation of the mobile phone 100 performed in response to contact to the touchpad 102.

FIG. 9 is a flowchart illustrating control processing performed by a modified mobile phone in response to input from the touchpad 102.

FIG. 10 is a flowchart illustrating key press judgment processing (Step S49 in FIG. 6) performed by the modified mobile phone.

### DESCRIPTION OF EMBODIMENTS

In the following, description is made on a mobile phone as one embodiment of the portable terminal pertaining to the present invention.

### Embodiment 1

<Exterior Appearance>

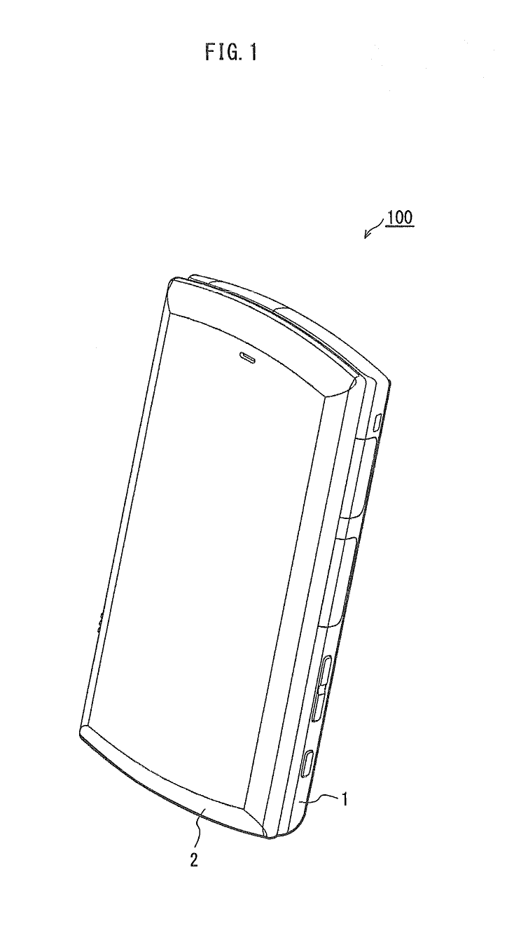

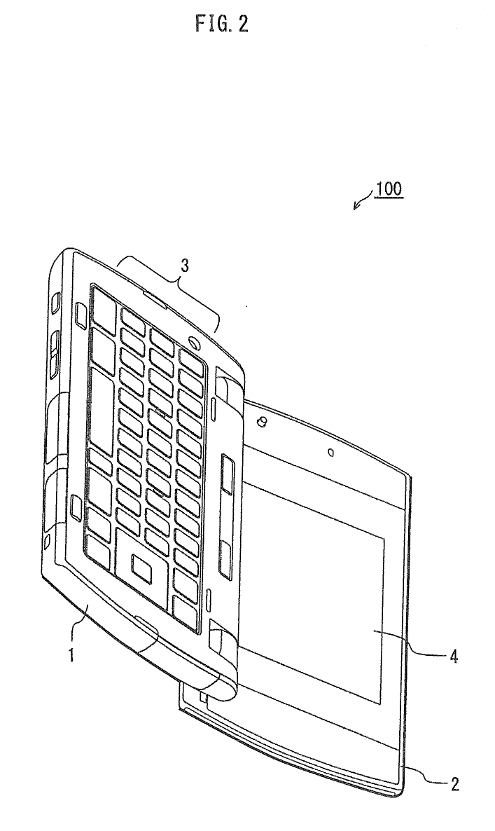

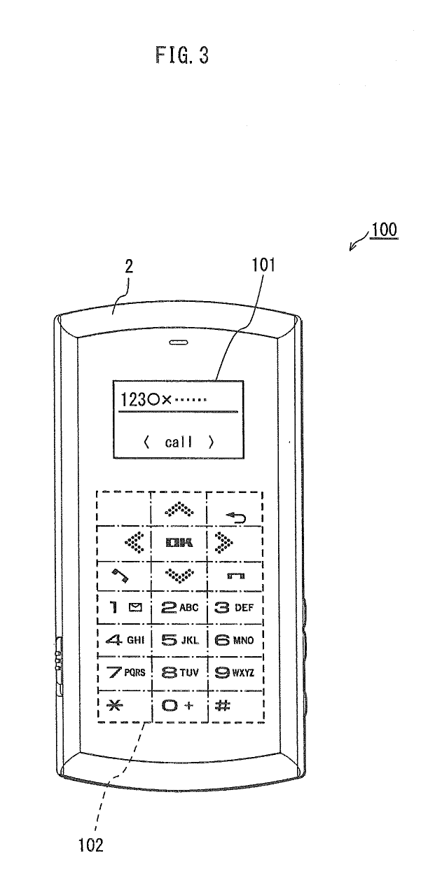

FIG. 1 is a perspective view illustrating the exterior appearance of a mobile phone 100 pertaining to embodiment 1 during a closed state thereof. FIG. 2 is a perspective view illustrating the exterior appearance of the mobile phone 100 pertaining to embodiment 1 during an open state thereof FIG. 3 is a front elevational view illustrating the exterior appearance of the mobile phone 100 pertaining to embodiment 1 during a closed state thereof.

As illustrated in FIGS. 1 and 2, the mobile phone 100 is a flip-type mobile phone which opens vertically with respect to a longitudinal direction thereof. The mobile phone 100 is composed of a housing 1 and a housing 2 which are joined in a mutually openable state. The housing 1 is provided with input keys 3, and the housing 2 is provided with an LCD (Liquid Crystal Display) 4 which is used as a screen for displaying information.

In addition to the above, and although not depicted in FIG. 1, the mobile phone 100 includes a sub LCD 101 and a touch pad 102, both of which are disposed on an external surface of the housing 2 which is exposed to the outside when the mobile phone 100 is in a closed state thereof. Illustrations of the sub LCD 101 and the touchpad 102 are found in FIG. 3.

The touchpad 102 includes a resin sheet having transmissive portions, and a backlight 103 (undepicted in FIG. 3) which is an LED or the like and which is disposed under the resin sheet. Each of the transmissive portions is provided in a shape of a mark which represents one of various keys provided to the mobile phone 100. The marks representing the various keys of the mobile phone 100 are made visible to a user while the backlight 103 is on. More specifically, the marks are made visible by light emitted from the backlight 103 passing through the transmissive portions of the resin sheet. A user causes the mobile phone 100 to perform processing allocated to a certain key by putting his/her finger or the like in contact with a location on the touchpad 102 having the mark representing the certain key.

In FIG. 3, the touchpad 102 is illustrated as being divided into multiple areas by dashed-dotted lines. Each of the areas indicates an area (approximately 5 mm×10 mm, for example) corresponding to one of the keys. Note that the dashed-dotted lines are illustrated for the mere sake of explanation, and are not visible to the user. Further, the key indicated by the mark “1” is referred to, for example, as the “1 key” hereinafter, and the same applies to the keys represented by the rest of the marks illustrated in FIG. 3.

In addition, it is to be noted that the types of keys which are provided to the touchpad 102 and the order in which the keys are arranged in the illustration of FIG. 3 are mere examples, and are to be altered as necessary.

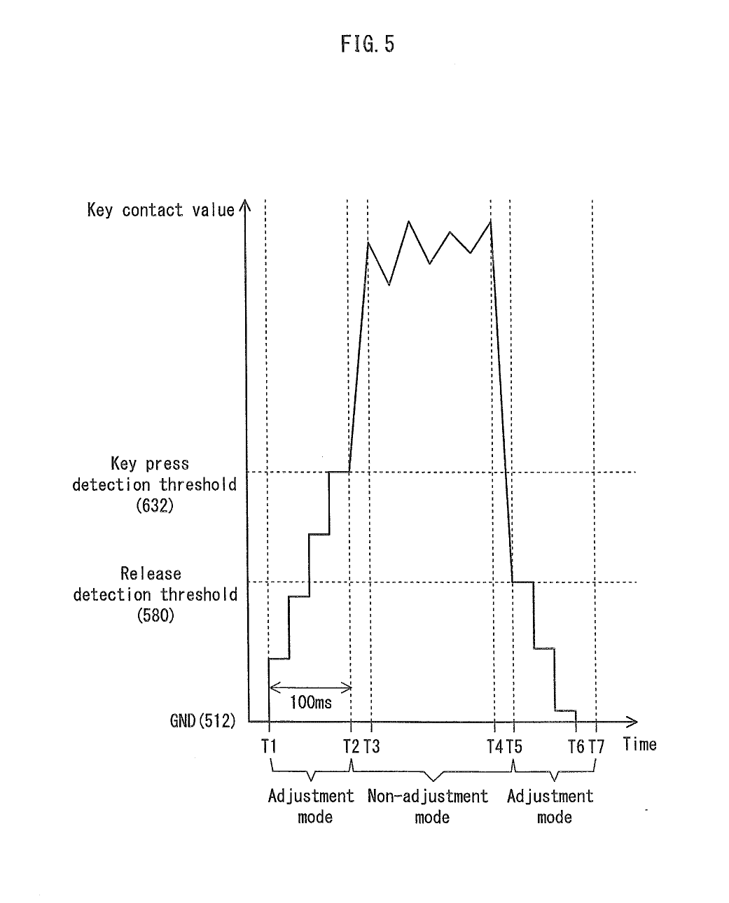

Additionally, in the present embodiment, the term “contact” not only refers to a state where a user's finger, face, or other body parts, or objects such as a touch pen is put into direct contact with the touchpad. The term “contact” also refers to a state where a user's finger, face, or other body parts, or objects such as a touch pen, all of which being capable of changing the electrostatic capacity of the touchpad 102, comes in close proximity to the touchpad and thus, causes a later-described key contact value (refer to FIG. 5) to equal or exceed a GND level.

Further, in the following explanation, the term “press” is used to indicate a state where the user contacts the touchpad 102 with the user of his/her finger or the like, and thereby selects a key on the touchpad 102.

<Structure>

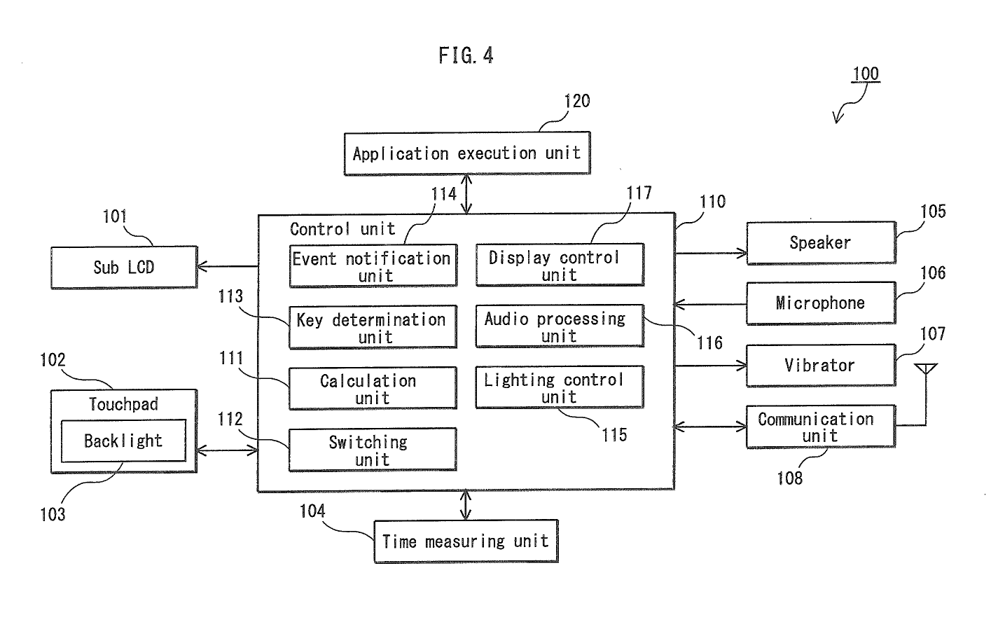

FIG. 4 is a block diagram illustrating the functional structure of main components of the mobile phone 100.

As illustrated in FIG. 4, the mobile phone 100 includes the sub LCD 101, the touchpad 102, a time measuring unit 104, a speaker 105, a microphone 106, a vibrator 107, a communication unit 108, a control unit 110, and an application execution unit 120.

The mobile phone 100 includes a processor and a memory in the structure thereof. The functions of the control unit 110 and the application execution unit 120 are realized by the processor executing a program stored onto the memory. Note that, hereinafter, it is presumed that various threshold values, which are to be later-described, are stored onto the memory.

The sub LCD 101 displays images such as characters by receiving instructions from the control unit 110.

The touchpad 102 includes a conventional capacitive touch sensor (undepicted) and a backlight 103 which turns on/off according to instructions received from the control unit 110. The touchpad 102 is a circuit for detecting contact made thereto by the user and for transmitting at least one pair of values to the control unit 110 while the contact is being detected. Each of the at least one pair of values consists of a coordinate value (x, y) indicating a position on the touchpad to which contact is made, and a value indicating the electrostatic capacity of the contacted position. More specifically, the touchpad 102, while contact is being detected, transmits the at least one pair of values to the control unit 110 every time a unit interval (25 ms, for example) elapses, and when contact is being made to multiple positions on the touchpad 102, the touchpad 102 transmits a plurality of pairs of values to the control unit 110.

In FIG. 3, the touchpad 102 is illustrated as a rectangular area surrounded by broken lines. As for examples of coordinate values of positions on the touchpad 102, the top left vertex of the rectangle representing the touchpad 102 is denoted by a coordinate value (0, 0), whereas the bottom right vertex of the rectangle representing the touchpad 102 is denoted by a coordinate value (160, 220).

The time measuring unit 104 is embodied as a timer or a counter, and according to instructions provided from the control unit 110, performs the measurement of time. In detail, the time measuring unit 104 commences the measurement of time by receiving an instruction from the control unit 110, and transmits a notification to the control unit 110 when a lighting interval (10 s, for example) elapses.

The lighting interval as referred to herein is a threshold used in a judgment of whether the backlight 103 is to be turned off. Here, it is presumed that the lighting interval has been preset by the manufacturer or the like of the mobile phone 100.

The communication unit 108 is a circuit for performing transmission/reception of radio waves with a base station via an antenna. More specifically, the communication unit 108 is provided with the functions of: receiving signals from the base station; demodulating the received signals; and transmitting the demodulated signals to the control unit 110, as well as the functions of: receiving signals transmitted from the control unit 110; modulating the received signals; and transmitting the modulated signals to the base station.

The control unit 110 has, in addition to the functions provided to a conventional mobile phone, the functions of an OS (operating system). That is, the control unit 110, based on a pair of values received, notifies the application execution unit 120 of an event. Each pair of values consists of a coordinate value of the contacted position and an electrostatic value of the contacted position. Further, the event includes information identifying a key of the touchpad 102 being pressed. The control unit 110 includes: a calculation unit 111; a switching unit 112; a key determination unit 113; an event notification unit 114; a lighting control unit 115; an audio processing unit 116; and a display control unit 117.

The calculation unit 111 performs the management of positions (coordinate areas) of the keys on the touchpad 102. In addition, the calculation unit 111 calculates a value (referred to hereinafter as a “key contact value”) which increases/decreases within a range between 0-1024, for each of the keys contacted. The calculation is based on the at least one pair of values transmitted by the touchpad 102, each of which consisting of a coordinate value (x, y) indicating a contacted position and the electrostatic capacity value of the contacted position.

Furthermore, the calculation unit 111 switches between two modes according to instructions provided by the switching unit 112, one of the modes being a non-adjustment mode and the other being an adjustment mode. As already mentioned above, the calculation unit 111 calculates, for each of the contacted keys, a value which increases/decreases between 0-1024 according to the increase/decrease of contact area within a coordinate area corresponding to the contacted key. Following this, in the non-adjustment mode, the calculation unit 111 sets the calculated value as the key contact value without performing any adjustment. On the other hand, in the adjustment mode, the calculation unit 111 sets, as the key contact value, a value obtained by performing adjustment on the calculated value. More specifically, the calculation unit in the adjustment mode performs the adjustment such that an amount of change, or a difference, between a key contact value of a contacted key and a previous key contact value of the same contacted key which has been determined a unit interval ago (25 ms, in this example) is smaller than or equal to a predetermined value (“30”, in the following description). The same calculation and adjustment is performed for each of the contacted keys.

Thus, in the adjustment mode, when the difference between the calculated value of a contacted key and the previous key contact value of the same contacted key which has been determined a unit interval ago is smaller than or equal to the predetermined value, the calculated value is set as the key contact value. On the other hand, when the difference between the calculated value of the contacted key and the previous key contact value of the same contacted key is greater than the predetermined value, the key contact value is determined as a value obtained by adding the predetermined value to the previous key contact value.

As the calculated value of a contacted key, or that is, the value which increases/decreases between 0-1024 according to the increase/decrease of contact area within a coordinate area corresponding to the contacted key, a value obtained by performing scale conversion on a sum total of the electrostatic capacity values within the coordinate area of the contacted key such that the converted value is between 0-1024 may be used, for example.

Detailed description on how a key contact value of a contacted key changes according to the switching between the two modes of the calculation unit 111 is provided in the following (refer to FIG. 5).

The switching unit 112 causes the calculation unit 111 to switch between the two modes thereof according to the current mode of the calculation unit 111 (non-adjustment mode or adjustment mode) and the key contact values calculated by the calculation unit 111.

In detail, the switching unit 112 causes the calculation unit 111 to switch from the adjustment mode to the non-adjustment mode when a key contact value calculated by the calculation unit 111 exceeds a key press detection threshold. In contrast, the switching unit 112 causes the calculation unit 111 to switch from the non-adjustment mode to the adjustment mode when all of the key contact values calculated by the calculation unit 111 fall below a release detection threshold.

Here, the key press detection threshold is a threshold used for judging whether a key has been pressed, and a value thereof is, for example, “632”. The release detection threshold is a threshold used for judging whether a key has been released, and a value thereof is, for example, “580”.

Detailed explanation of the timing at which the switching unit 112 causes the calculation unit 111 to switch between the two modes thereof is provided in the following (refer to FIG. 5).

The key determination unit 113 determines one key (referred to hereinafter as a “target key”) according to the key contact values calculated by the calculation unit 111. As mentioned in the following, the mobile phone 100 executes a processing allocated to the target key.

The key determination unit 113 generally determines, as the target key, a key having the greatest key contact value among the keys having key contact values equal to or greater than the key press detection threshold (632). However, exceptional cases exist, where the target key is not determined in such a manner. Such cases include (i) a case (referred to hereinafter as “multiple key press”) where the number of keys having key contact values equal to or greater than a multiple key press detection threshold (“580”, for example) exceeds a predetermined number of keys, and (ii) a case where there exists, between a combination of two of the keys having key contact values equal to or greater than a multiple key press detection threshold, a key having a key contact value smaller than or equal to the release detection threshold (580).

Such cases are exceptional, since, in such cases, it can be assumed that erroneous contact is being made to the touchpad 102. That is, the contact is not a result of a normal user operation where the user contacts the touchpad 102 using his/her fingers or the like. Therefore, in cases where erroneous contact is being made to the touchpad 102, it is necessary to inhibit the target key from being determined and accordingly to inhibit the processing allocated to the target key (referred to as “key allocated processing” hereinafter) from being erroneously executed. Erroneous contact as referred to herein includes contact being made to the touchpad 102 in such cases as where a user's body part besides his/her finger contacts the touchpad 102, or where an object which is disposed in a user's bag along with the portable terminal contacts the touchpad 102 of the portable terminal.

Further, with regards to the above-stated predetermined number of keys according to which multiple key press is determined, the predetermined number of keys is to be set to a number of keys which cannot be simultaneously contacted when the user is making operations to the keys by using his/her finger or the like. In the following description, the predetermined number of keys is set presuming that, when the user is using one finger to make key operations on the touchpad 102, the maximum number of keys the user can simultaneously contact is four. The four keys which can be simultaneously contacted in such a case include: a key the user intends to press; a key located either to the right of or to the left of the intended key; a key located either above or below the intended key; and a key adjacent to the intended key in a diagonal direction. Therefore, based on this presumption, multiple key press is determined in cases where five or more keys are detected having key contact values equal to or greater than the multiple key press detection threshold. Further, in the following description, it is also presumed that, once the key determination unit 113 determines a target key, the determination of a subsequent target key is not performed until the key contact values of all of the keys of the touchpad 102 fall below or equal the release detection threshold.

The event notification unit 114 notifies the application execution unit 120 of an event. An event includes information identifying the target key which has been determined by the key determination unit 113.

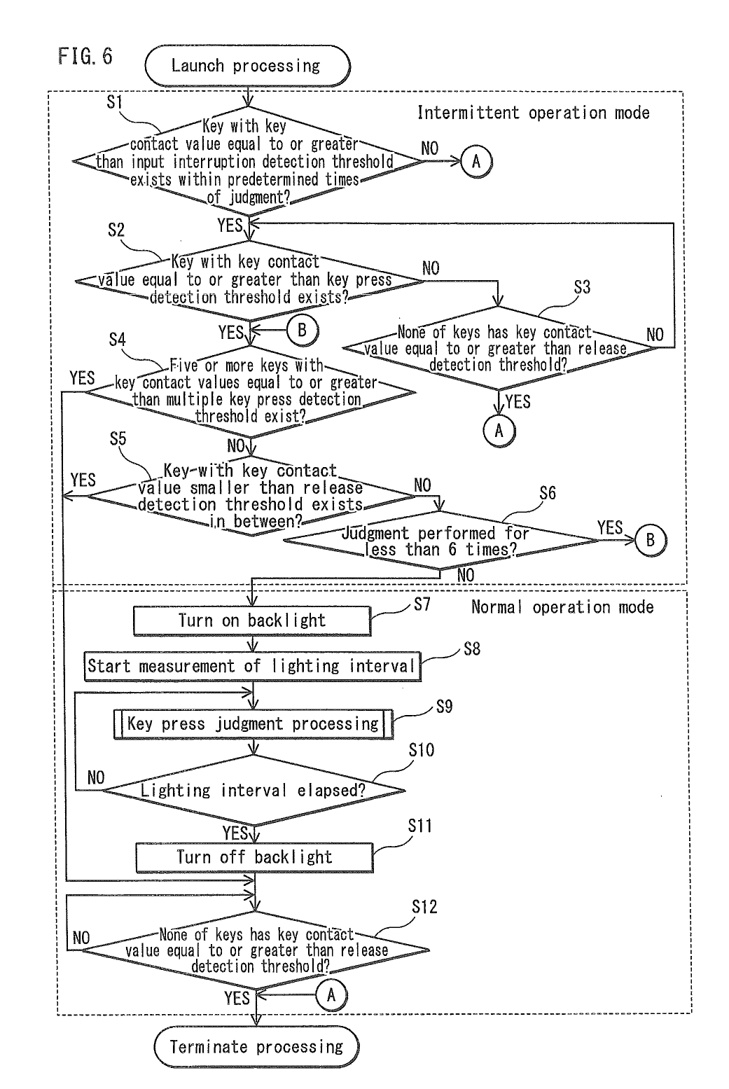

The lighting control unit 115 controls the turning on/off of the backlight 103 according to the key contact values calculated by the calculation unit 111. Description on how the turning on/off of the backlight 103 is controlled is provided in the following (refer to FIG. 6).

The audio processing unit 116 performs D/A (Digital/Analog) conversion of audio signals received via the communication unit 108 and outputs the converted signals audio via the speaker 105. Additionally, the audio processing unit 116 performs A/D (Analog/Digital) conversion on audio signals input from the microphone 106, and transmits the converted audio signals via the communication unit 108.

The display control unit 117 causes the sub LCD 101 to display images and the like according to instructions received from the application execution unit 120.

The application execution unit 120 is an event-driven application which executes processing in accordance with the event notified from the control unit 110.

<Key Contact Value>

In the following, description is made on how a key contact value of a key contacted by a user's finger or the like changes according to which mode the calculation unit 111 is in, with reference to the accompanying FIG. 5.

FIG. 5 illustrates changes observed in a key contact value calculated by the calculation unit 111.

In FIG. 5, the horizontal axis indicates time, whereas the vertical axis indicates a key contact value of a specific key which has been contacted by a user's finger or the like. Note that FIG. 5 does not illustrate the change of the key contact value when the key contact value is between 0-511. Further, the GND level (set to “512”, for example) illustrated in FIG. 5 is a threshold for judging whether a key is in contact with the user's finger or the like.

In addition, in the following description, it is presumed that the interval between times T1 and T2 in FIG. 5 and the interval between times T5 and T7 in FIG. 5 are commonly 100 ms. This interval of 100 ms is hereinafter referred to as a “frame interval”. Further, it is presumed that the calculation unit 111 is in adjustment mode at time T1.

Time T1 indicates a timing at which contact to a certain key by a user's finger or the like is started.

When contact is made to the key, the value which increases/decreases according to the increase/decrease of contact area within the coordinate area corresponding to the key exceeds the key press detection threshold. However, since the calculation unit 111 is in adjustment mode between times T1 and T2, the calculation unit 111 performs adjustment to the value associated with the key, and sets the adjusted value as the key contact value. More specifically, the key contact value calculated is a value having been adjusted such that the change thereof during the unit interval (25 ms, in this example) is within a predetermined value (set to “30”, in this example). Hence, the key contact value of the key increases in a staircase-like manner between times T1 and T2.

Time T2 indicates a timing at which the key contact value of the key equals or exceeds the key press detection threshold.

Since the switching unit 112 is configured to cause the calculation unit 111 to switch to non-adjustment mode when the key contact value equals or exceeds the key press detection threshold, the calculation unit 111 is switched to non-adjustment mode at time T2. As a result, from this point, the calculation unit 111 sets the value which increases/decreases according to the increase/decrease of contact area within the coordinate area corresponding to the contacted key as the key contact value without performing adjustment thereto, and thus, the key contact value increases rapidly between times T2 and T3. Following this, and until time T5, the key contact value changes according to the increase/decrease in the area to which contact is made within the coordinate area of the touchpad 102 corresponding to the key.

Time T4 indicates a timing at which the contact to the key by the user's finger or the like is released. As mentioned above, the contact to the key by the user's finger or the like has been started at time T1.

Since the calculation unit 111 is still in non-adjustment mode between times T4 and T5, the key contact value decreases rapidly.

Time T5 indicates a timing at which the key contact value equals or falls below the release detection threshold.

Since the switching unit 112 is configured to cause the calculation unit 111 to switch to adjustment mode when the key contact value falls below or equals the release detection threshold, the calculation unit 111 is switched to adjustment mode at time T5. As a result, the calculation unit 111 performs adjustment to the value which increases/decreases according to the increase/decrease of contact area within the coordinate area corresponding to the key, and sets the adjusted value as the key contact value. More specifically, the key contact value calculated is a value having been adjusted such that the change thereof during the unit interval (25 ms) is within a predetermined value (30). Hence, the key contact value of the key decreases in a staircase-like manner between times T5 and T6.

By causing the calculation unit 111 to switch between the two modes as described above, the risk of processing allocated to keys other than the key whose processing the user intended to execute being performed (erroneous operation) is reduced in the mobile phone 100. At the same time, such a configuration makes it possible for the mobile phone 100 to respond quickly to continuous key operations performed by the user.

In the following, the effects yielded by configuring the calculation unit 111 to switch between the two modes thereof are described in further detail.

As description has already been made in the above, a key contact value is calculated by the calculation unit 111 based on the at least one electrostatic capacity value which is output from the touchpad 102. Here, it should be noted that the electrostatic capacity value also changes when affected by noises. Such noises are generated when phone calls are made, or photographs are taken utilizing a camera function provided to a conventional mobile phone.

Further, as described in the above, the key determination unit 113 determines a key having a key contact value equal to or greater than the key press detection threshold (632) as the target key, and the mobile phone 100 executes the processing allocated to the determined target key. Such being the case, the change of key contact values occurring due to noise is problematic. That is, in a case where key contact values suddenly exceed the key press detection threshold by being affected by noise, there is a risk of erroneous operation.

However, such erroneous operation is appropriately prevented by the structure of the present embodiment. As already mentioned in the above, the calculation unit 111 operates in adjustment mode between time T1 being the timing at which contact to the key is started and time T2 being the timing at which the key contact value of the contacted key equals or exceeds the key press detection threshold. Therefore, the calculation unit 111 outputs, as the key contact value, a value which has been adjusted such that the change thereof during the unit interval is within the predetermined value (30). Hence, a case is appropriately prevented where the key contact values suddenly exceed the key press detection threshold due to being affected by noise, and accordingly, the occurrence of erroneous operation as mentioned above is inhibited.

In addition, and as already has been mentioned in the above, once a target key has been determined, the key determination unit 113 does not perform the determination of a subsequent target key until contact being made to all of the keys is released and the key contact values of all keys on the touchpad 102 have fallen below or equal to the release detection threshold. As such, the calculation unit 111 operates in non-adjustment mode between times T2 and T5. Thus, when the user's finger or the like is released at time T4, the key contact value of the contacted key decreases rapidly, until the key contact value equals the release detection threshold at time T5 in FIG. 5.

Thus, for example, if supposing that the key corresponding to the key contact value illustrated in FIG. 5 is the only key contacted by the user's finger or the like, the determination of a subsequent target key will be made possible after time T5. Therefore, when compared to a case where the calculation unit 111 operates in adjustment mode between times T2 and T5, the mobile phone is able to respond with an enhanced level of quickness to continuous key operations by the user.

<Operation>

<Control Processing>

In the following, description is provided on the operation of the mobile phone 100 having the aforementioned structure, with reference to the accompanying FIG. 6.

FIG. 6 is a flowchart illustrating control processing performed by the mobile phone 100 in response to input from the touchpad 102.

The two portions surrounded by broken lines in FIG. 6 each denote processing performed in an intermittent operation mode and a normal operation mode of the processor provided to the mobile phone 100. The intermittent operation mode refers to a power-saving state of the processor where the processor operates for a predetermined interval (10 ms, for example) within each frame interval (100 ms, in this example). Note that the predetermined interval is set to be shorter than the frame interval. In contrast, the normal operation mode refers to a state of the processor where the processor is in operation at any given point in time.

Further, although not illustrated in FIG. 6, the processor is in sleep mode waiting for input interruption to be made from the touchpad 102 prior to the launch of the control processing described hereinafter. Similarly, when the control processing to be described hereinafter is terminated, the processor returns to sleep mode.

Note that, the sleep mode may be realized, for example, by stopping the clock signal sent to the processor from a clock generator (undepicted). Similarly, the intermittent operation mode may be realized by causing the clock generator to supply the processor with the clock signal for only the predetermined interval within every frame interval by using a timer (undepicted). Finally, the normal operation mode may be realized by causing the clock generator to supply the processor with the clock signal at all times.

Further, although not illustrated in FIG. 6, the calculation of key contact values is executed separately from the control processing to be described in the following. More specifically, when a pair of values consisting of a coordinate value (x, y) of a contacted position and an electrostatic capacity value of the contacted position is received from the touchpad 102, or in other words, when input interruption is made from the touchpad 102, the processor enters the intermittent operation mode from the sleep mode, and executes a program stored onto the memory. Hence, the calculation unit 111 of the control unit 110 launches the calculation of the key contact values of the keys to which contact is being made, and performs the calculation every time a unit interval elapses. Starting at this point and until the processor returns to sleep mode, the calculation of key contact values is performed.

Additionally, the following description is made under the presumption that the calculation unit 111 is initially in adjustment mode.

When the processor enters intermittent operation mode from sleep mode, the lighting control unit 115 of the control unit 110 performs a judgment of whether there is a key having a key contact value which is equal to or greater than an input interruption detection threshold (Step S1). The judgment is performed for every frame interval (100 ms, in this example) that elapses, and is performed based on the latest key contact values of each of the keys calculated by the calculation unit 111. When it is judged, within a predetermined number of times (twice, for example) of judgment, that none of the keys has a key contact value equal to or greater than the input interruption detection threshold (Step S1: NO), the control processing terminates without any processing actually being carried out, and the processer returns to sleep mode.

The input interruption detection threshold as referred to here is a threshold which is used to judge whether or not to execute a judgment processing (corresponding to Steps S2 through S6 in the following), and a value thereof is “580”, for example. In the judgment processing, a judgment is made of whether or not to execute lighting processing of the backlight 103 according to contact made to the touchpad 102.

When it is judged that one or more keys have key contact values equal to or greater than the input interruption detection threshold (Step S1: YES), the lighting control unit 115 proceeds to judging whether there is a key having a key contact value which is equal to or greater than the key press detection threshold (“632”, in this example) among the one or more keys having key contact values equal to or greater than the input interruption detection threshold (Step S2). When none of the one or more keys has a key contact value equal to or greater than the key press detection threshold (Step S2: NO), the lighting control unit 115 further proceeds to judging whether or not none of the keys has a key contact value equal to or greater than the release detection threshold (Step S3).

When none of the keys has a key contact value equal to or greater than the release detection threshold (Step S3: YES), the processing is terminated and the processor enters sleep mode. When it is judged that one or more of the keys have key contact values equal to or greater than the release detection threshold (Step S3: NO), the processing is launched once again from Step S2 after a frame interval (100 ms, in this example) elapses. When it is judged that there is a key having a key contact value equal to or greater than the key press detection threshold (Step S2: YES), the lighting control unit 115 judges whether five or more keys have key contact values equal to or greater than the multiple key press detection threshold (Step S4). When five or more keys have key contact values equal to or greater than the multiple key press detection threshold (Step S4: YES), the processing proceeds to the later-described Step S12. This is since the occurrence of multiple key press has been detected, and it is assumed that erroneous contact has been made to the touchpad 102, instead of contact made by the user by using his/her finger or the like with the intention of turning on the backlight 103. In such a case, the turning on of the backlight 103 is to be inhibited.

When less than five keys have key contact values equal to or greater than the multiple key press detection threshold (Step S4: NO), the lighting control unit 115 judges whether there is a key (i) which is in between, or in other words, commonly adjacent to a combination of two of the less than five keys having key contact values equal to or greater than the multiple key press detection threshold, and (ii) which has a key contact value smaller than or equal to the release detection threshold (Step S5). This judgment is performed with respect to all combinations of two of the less than five keys having key contact values equal to or greater than the multiple key press detection threshold.

In addition, the above judgment of Step S5 can be performed with respect to two keys which have key contact values equal to or greater than the multiple key press detection threshold and which, however, do not belong to the same horizontal row or the same vertical row. For example, supposing that when the 1 key and the 8 key have key contact values equal to or greater than the multiple key press detection threshold, the lighting control unit 115 determines, as a key commonly adjacent to both the 1 key and the 8 key, a key (i) which is located in the horizontal row in between the horizontal rows in which the 1 key and the 8 key are located, and (ii) which is, at the same time, located in the vertical rows including and in between the vertical rows in which the 1 key and the 8 key are located (the 4 key and the 5 key, in this example).

Similarly, when four keys, namely the 1 key, the 3 key, the 4 key, and the 6 key, have key contact values equal to or greater than the multiple key press detection threshold, the lighting control unit 115 determines, as keys commonly adjacent to two of the four keys, the 2 key and the 5 key, and further judges whether at least one of the 2 key and the 5 key has a key contact value which is smaller than or equal to the release detection threshold. A positive judgment is made (Step S5: YES) when at least one of the 2 key and the 5 key, in this example, has a key contact value smaller than or equal to the release detection threshold, while, on the other hand, a negative judgment is made (Step S5: NO) when both the 2 key and the 5 key have key contact values higher than the release detection threshold.

In the judgment of Step S5, when there is no key commonly adjacent to combinations of two of the less than five keys having key contact values equal to or greater than the multiple key press detection threshold, the lighting control unit 115 makes a negative judgment (Step S5: NO). One example is when the 1 key and the 2 key have key contact values equal to or greater than the multiple key press detection threshold. Since there is no key commonly adjacent to the 1 key and the 2 key, the lighting control unit 115 makes a negative judgment.

In Step S5, when there is a key (i) which is commonly adjacent to a combination of two of the less than five keys having key contact values equal to or greater than the multiple key press detection threshold and (ii) which has a key contact value smaller than or equal to the release detection threshold (Step S5: YES), the processing proceeds to Step S12 which is to be described in the following.

The judgment in Step S5 is performed on the assumption that, when the user is performing a normal user operation on the touchpad 102 by using his/her finger or the like, the user's finger or the like would normally contact a key commonly adjacent to two keys which have key contact levels equal to or greater than the multiple key press detection threshold. By such a configuration being made, the present invention prevents the backlight 103 from lighting in such a case as where the commonly adjacent key has a key contact value smaller than or equal to the release detection threshold, since in such a case, it can be assumed that the contact has not been made as a result of a normal user operation made by a user by using his/her finger or the like.

In contrast, when there are one or more keys commonly adjacent to combinations of two keys having key contact values equal to or greater than the multiple key press detection threshold, but however, the one or more keys have key contact values greater than the release detection threshold (Step S5: NO), the processing proceeds to Step S6. In Step S6, a judgment is made of whether or not the judgments of Steps S4 and S5 have been performed less than a predetermined number of times (6 times, in this example) since the launch of the control processing. When the judgments of Steps S4 and S5 have been performed less than 6 times since the launch of the control processing (Step S6: YES), the processing of Steps S4 and S5 are performed once again following the elapse of a frame interval (100 ms, in this example).

In contrast, when the judgments of Steps S4 and S5 have already been performed for the predetermined number of times (Step S6: NO), the processor enters normal operation mode from the intermittent operation mode. In addition, the lighting control unit 115 causes the backlight 103 to turn on (Step S7), and causes the time measuring unit 104 to commence the measurement of lighting interval from this point (Step S8).

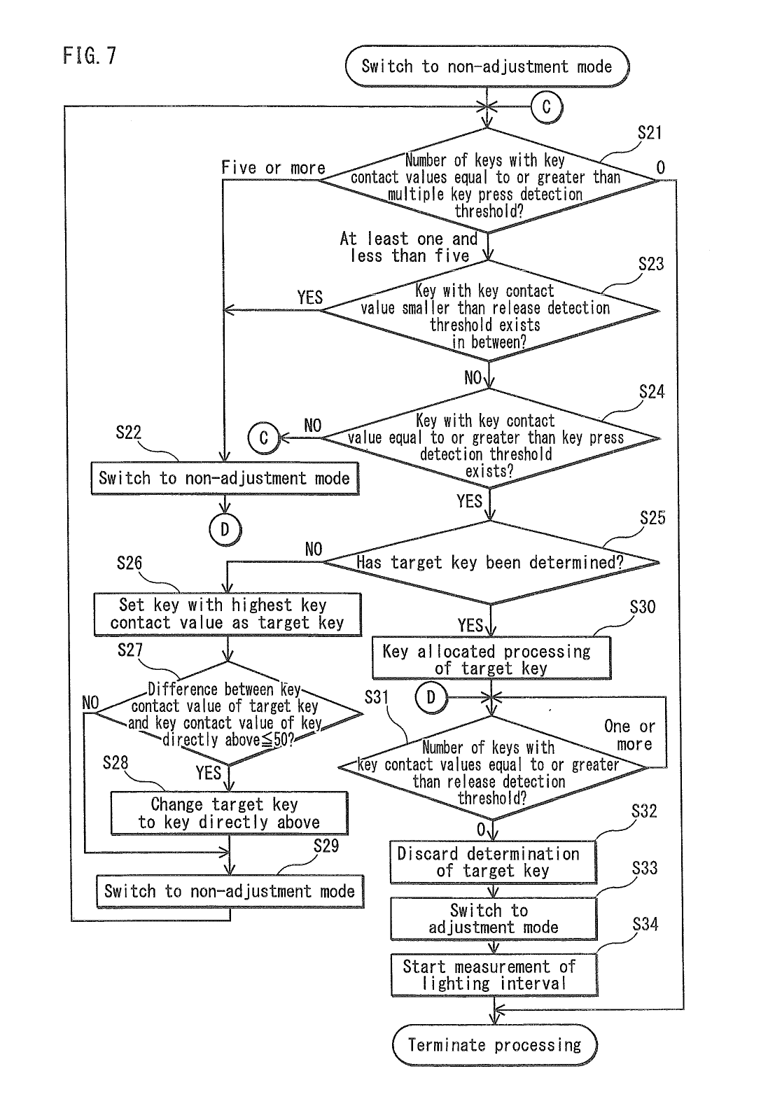

Subsequently, the control unit 110 performs the later-described key press judgment processing (refer to FIG. 7) (Step S9), and the lighting control unit 115 judges whether a lighting interval has elapsed (Step S10). More specifically, a positive judgment is made by the light controlling unit 115 (Step S10: YES) when a notification is received from the time measuring unit 104 that a lighting interval has elapsed.

Additionally, when it is judged that contact has been made to the keys in the key press judgment processing of Step S9, as description is made in the following, the time measuring unit 104 resets and restarts the measurement of lighting interval (refer to Step S34 in FIG. 7). Hence, in view of the above, a positive judgment is made in Step S10 (Step S10: YES) either (i) in a case where the backlight 103 is turned on in Step S7, the measurement of lighting interval is commenced in Step S8, and a lighting interval elapses without any contact being made to the keys, or (ii) in a case where a lighting interval elapses from when a previous contact to a key on the touchpad 102 was made.

When it is judged that a lighting interval has not yet elapsed (Step S10: NO), the processing restarts from Step S9. On the other hand, when it is judged that a lighting interval has elapsed (Step S10: YES), the lighting control unit 115 turns the backlight 103 off (Step S11).

Following this, the lighting control unit 115 judges whether none of the keys of the touchpad 102 has a key contact value equal to or greater than the release detection threshold (Step S12). The judgment is performed based on the latest key contact values of each of the keys calculated by the calculation unit 111. While there exists a key having a key contact value equal to or greater than the release detection threshold (Step S12: NO), the judgment processing of Step S12 is performed for every frame interval (100 ms, in this example) elapsing. On the other hand, when none of the keys has a key contact value equal to or greater than the release detection threshold (Step S12: YES), the control processing is terminated, and the processer enters sleep mode.

As such, even when there is a key on the touchpad having a key contact value equal to or greater than the key press detection threshold, if it is judged that the contact to the key results from erroneous contact, the risk is reduced of the backlight being turned on, and accordingly, a cut down in electrical consumption is realized. This is made possible by detecting erroneous contact, which includes multiple key press and another state of contact where a key contact value of a key which is commonly adjacent to two keys having key contact values equal to or greater than the multiple key press detection threshold is smaller than or equal to the release detection threshold. Such states of contact are unlikely to take place when the user is performing a normal user operation by using his/her finger or the like.

In addition, even when there is a key on the touchpad having a key contact value equal to or greater than the key press detection threshold, if it is judged that the contact to the key results from erroneous contact, the processor enters sleep mode from intermittent operation mode rather than entering normal operation mode, and thus realizes a cut down in electrical consumption. This is made possible by detecting such erroneous contacts, which include multiple key press and other states of contact which are unlikely to take place when the user is using his/her fingers or the like to make key operations.

<Key Press Judgment Processing>

In the following, detailed description is provided on the key press judgment processing of Step S9.

FIG. 7 is a flowchart illustrating the key press judgment processing (Step S9 in FIG. 6) performed by the mobile phone 100.

As illustrated in FIG. 7, the key determination unit 113 determines the number of keys having key contact values equal to or greater than the multiple key press detection threshold (Step S21). The judgment is made based on the latest key contact values calculated by the calculation unit 111. When none of the keys has a key contact value equal to or greater than the multiple key press detection threshold (Step S21: 0), the key determination unit 113 terminates the key press judgment processing without performing any processing.

When there are five or more keys having key contact values equal to or greater than the multiple key press detection threshold (Step S21: five or more), the switching unit 112 causes the calculation unit 111 to switch to non-adjustment mode (Step S22), and the processing proceeds to the later-described Step S31.

In Step S22, the calculation unit 111 is caused to switch to non-adjustment mode to allow the determination of the next target key to be performed as quickly as possible. More specifically, when multiple key press is detected, the calculation unit enters non-adjustment mode from adjustment mode as described above. Thus, when the contact made to the keys is released, the key contact values of all of the keys to which contact had been made rapidly falls below the key press detection threshold.

Further, the processing proceeds to Step S31 to prevent the execution (erroneous operation) of a later-described key allocated processing of Step 30. Such configuration is made in view of cases of multiple key press, where it is assumed that the contact made to the touchpad 102 is not a result of a normal user operation performed by the user by using of his/her fingers or the like, and thus there is a need of preventing the key allocated processing from being executed.

In Step S21, when there are one to four keys having key contact values equal to or greater than the multiple key press detection threshold (Step S21: at least one and less than five), the key determination unit 113 performs a processing similar to the processing in the aforementioned Step S5. That is, the key determination unit 113 judges whether there is a key (i) which is commonly adjacent to a combination of two of the one to four keys having key contact values equal to or greater than the multiple key press detection threshold, and (ii) which has a key contact value which is smaller than or equal to the release detection threshold (Step S23). This judgment is performed with respect to all combinations of two of one to four keys having key contact values equal to or greater than the multiple key press detection threshold. When it is judged that there is such a key, it is assumed that the contact to the keys has not resulted from a normal user operation made by the user with use of his/her finger or the like. Such configuration is made since there is a need of preventing the execution (erroneous operation) of key allocated processing in such a case.

In a case where there is a key (i) which is commonly adjacent to a combination of two keys having key contact values equal to or greater than the multiple key press detection threshold and (ii) which has a key contact value smaller than or equal to the release detection threshold (Step S23: YES), the switching unit 112 causes the calculation unit 111 to switch to non-adjustment mode from adjustment mode (Step S22), and processing proceeds to the later-described Step S31. In contrast, when there are one or more keys adjacent to combinations of two keys having key contact values equal to or greater than the multiple key press detection threshold, but however, the one or more keys have key contact values greater than the release detection threshold (Step S23: NO), the key determination unit 113 judges whether there is a key having a key contact value equal to or greater than the key press detection threshold among the keys having key contact values equal to or greater than the multiple key press detection threshold. Note that the keys having key contact values equal to or greater than the multiple key press detection threshold have been preemptively detected in Step S21 (Step S24).

When none of the keys has a key contact value equal to or greater than the key press detection threshold (Step S24: NO), the processing restarts from Step S21. When there is key having a key contact value equal to or greater than the key press detection threshold (Step S24: YES), the key determination unit 113 subsequently judges whether the target key has been already determined (Step S25).

When the target key has not yet been determined (Step S25: NO), the key determination unit 113 determines the key having the highest key contact value, among the keys having key contact values equal to or greater than the key press detection threshold, as the target key (Step S26). In a case where two or more keys have the same highest key contact value, the target key is determined according to a predetermined order of priority of the keys. In this example, description is made under the presumption that keys which are located closer to the upper left edge of the touchpad 102 are given a higher priority. For instance, when three keys, namely the 1 key, the 2 key and the 4 key, have the same highest key contact value, the 1 key is determined as the target key.

In addition to this, the key determination unit 113 judges whether a value obtained by subtracting, from the key contact value of the target key, a key contact value of a key located directly above the target key is smaller than or equal to a predetermined value (set to “50”, in this example) (Step S27). When the value obtained in Step 27 is greater than the predetermined value (Step S27: NO), the switching unit 112 causes the calculation unit 111 to switch to non-adjustment mode from adjustment mode (Step S29), and processing restarts from Step S21.

When the value obtained by subtracting a key contact value of a key located directly above the target key from the key contact value of the target key is smaller than or equal to the predetermined value (Step S27: YES), the key determination unit 113 replaces the previous target key (the key having the highest key contact value) with a new target key which is the key directly above the previous target key (Step S28). Further, the switching unit 112 causes the calculation unit 111 to switch to non-adjustment mode from adjustment mode (Step S29), and processing restarts from Step S21.

The processing of Step S28 is incorporated as a countermeasure for such a case as where a pad of a finger, for example, contacts a key directly below the key which the user intended to press. In such a case, the key directly below the intended key will have the highest key contact value, which is problematic. Thus, in Step S28, when the value obtained by subtracting, from the highest key contact value, the key contact value of the key directly above the key having the highest key contact value is smaller than or equal to the predetermined value (50, in this example), it is determined that the key which the user actually intended to contact is the key directly above the key having the highest key contact value. Therefore, the key directly above the key having the highest key contact value is newly determined as the target key.

On the other hand, when it is judged that the target key has already been determined (Step S25: YES) in Step S25, the event notification unit 114 notifies the application execution unit 120 of an event. The application execution unit 120 executes a processing allocated to the target key (key allocated processing) based on the event notified (Step S30).

Here, the event is an event indicating that a key has been pressed, and includes information identifying the target key which is the key having been pressed.

In execution of the key allocated processing, the application execution unit 120 instructs the display control unit 117 of the control unit 110 to display, on the sub LCD 101, a number or the like indicating the target key identified by the information included in the event. Upon receiving the instruction, the display control unit 117 causes the sub LCD 101 to display a number or the like indicating the target key. The “number or the like indicating the target key” as referred to in the above includes a number or a symbol assigned to a target key, and for example, if the 1 key is the target key, “1” is displayed on the sub LCD 101, whereas if the * key is the target key, “*” is displayed on the sub LCD 101.

Subsequently, the key determination unit 113 determines the number of keys having key contact values equal to or greater than the release detection threshold (Step S31). The judgment here is made based on the latest key contact values each of which have been calculated by the calculation unit 111.

When one or more keys have key contact values equal to or greater than the release detection threshold (Step S31: one or more), the judgment of Step S31 is performed for every frame interval (100 ms, in this example) elapsing. When none of the keys has a key contact value equal to or greater than the release detection threshold (Step S31: 0), the key determination unit 113 discards the determination of the target key (Step S32), and the switching unit 112 causes the calculation unit 111 to switch to adjustment mode from non-adjustment mode (Step S33).

Further, the key determination unit 113 causes the time measuring unit 104 to reset and restart the measurement of lighting interval (Step S34), and thereby terminates the key press judgment processing.

<Explanation of Operation based on Examples>

In the following, description is made on the operation of the mobile phone 100 involved in the turning on/off of the backlight 103, based on examples. The operation to be explained hereinafter is a particularly important aspect of the present invention.

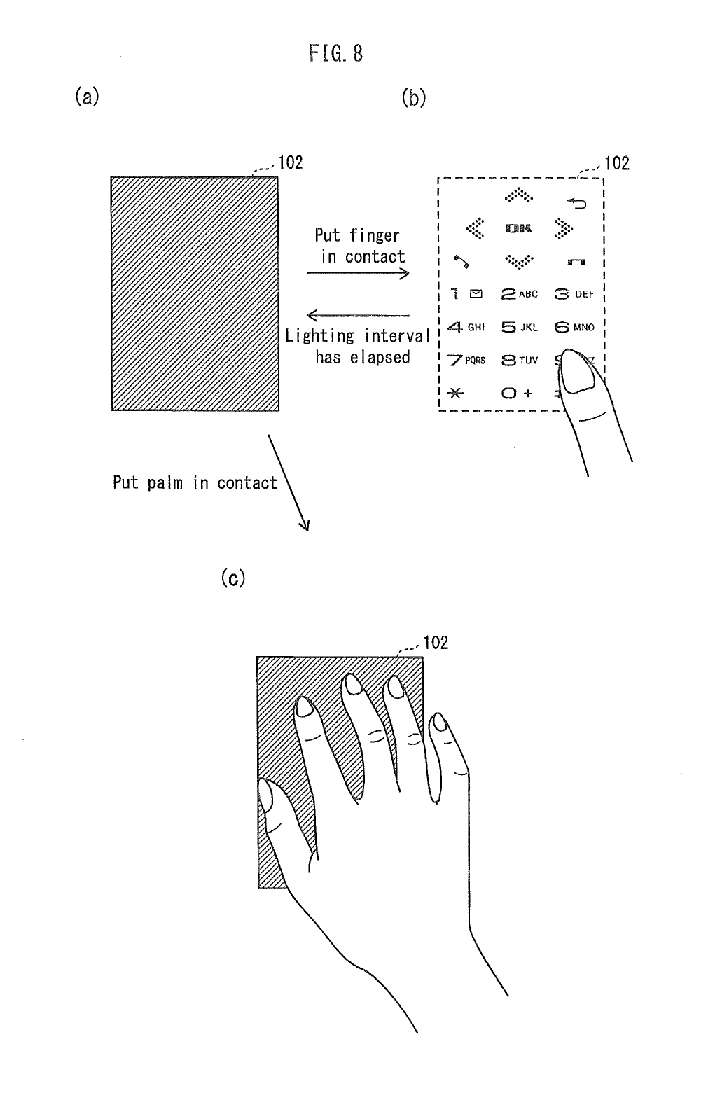

FIG. 8 illustrates an example of the operation of the mobile phone 100 performed in response to contact made to the touchpad 102.

Shaded portions of the touchpad 102 in FIG. 8 labeled (a) and (c) indicate that the backlight 103 is off, and that the marks provided on the touchpad 102 which represent the various keys of the mobile phone 100 are not visible to the user.

<A Case where a User Puts his/her Finger in Contact with the Touchpad>

Portion (a) of FIG. 8 illustrates the touchpad 102 where the backlight 103 is off. Description is made in the following of an example of the operation of the mobile phone 100 in a case where a user puts his/her finger in contact with the touchpad 102 in such a state, with reference to the flowcharts of the accompanying FIGS. 6 and 7.

In the following, description is provided under the presumption that no other contact is made to the touchpad 102 besides that made by the user putting one finger into contact therewith. Additionally, in the following, it is presumed that the processor of the mobile phone 100 is in the sleep mode at the start of the description.

Upon receiving input from the touchpad 102, the processor enters intermittent operation mode from sleep mode, and executes a program stored onto the memory. Thus, the key determination unit 113 judges whether there is a key having a key contact value equal to or greater than the input interruption detection threshold (Step S1 in FIG. 6). The judgment is performed based on the latest key contact values of each of the keys calculated by the calculation unit 111.

When the key contact values of the one or more keys contacted by the user's finger equals or exceeds the input interruption detection threshold (Step S1: YES), the key determination unit 113 subsequently makes a judgment of whether there is a key having a key contact value equal to or greater than the key press detection threshold (Step S2). When the key contact values of the one or more keys contacted by the user's finger equal or exceed the key press detection threshold (Step S2: YES), the key determination unit 113 performs two judgments. The first is the judgment of whether five or more keys have key contact values equal to or greater than the multiple key press detection threshold (Step S4). The second is the judgment of whether there is a key (i) which is commonly adjacent to a combination of two of the keys having key contact values equal to or greater than the multiple key press detection threshold, and (ii) which has a key contact value which is smaller than or equal to the release detection threshold (Step S5). Note that the second judgment is performed for all possible combinations of two keys having key contact values equal to or greater than the multiple key press detection threshold. Additionally, in this example, the judgments of Steps S4 and S5 are performed for every frame interval elapsing, and for six times in total. In a case where the user contacts the touchpad 102 with only one finger, both of the judgments of Step S4 and Step S5 yield negative results (Step S6: NO). As such, the processor enters normal operation mode from the intermittent operation mode. Further, the lighting control unit 115 causes the backlight 103 to turn on (Step S7) and causes the time measuring unit 104 to launch the measurement of lighting interval (Step S8), and the processing proceeds to the key press judgment processing (Step S9).

As a result of the processing of Step S7, the touchpad 102 enters a state where the backlight 103 is on as illustrated in portion (b) of FIG. 8.

When the touchpad 102 is on as is illustrated in portion (b) of FIG. 8, once the user contacts the 9 key with his/her finger, for example, the 9 key is determined as the target key (Step S26 in FIG. 7), and the processing (key allocated processing) allocated to the 9 key is executed (Step S30). Following this, the key determination unit 113 causes the time measuring unit 104 to reset and restart the measurement of lighting interval (Step S34), and thereby terminates the key press judgment processing.

Since the measurement of lighting interval has started in Step S34, a lighting interval has still not elapsed (Step S10: NO in FIG. 6) at this point. Hence, the key press judgment processing is launched once again (Step S9).

When the touchpad 102 is on as is illustrated in portion (b) of FIG. 8, and no key operations are made by the user thereto, for example, the number of keys judged to have key contact values equal to or greater than the multiple key press detection threshold is “0” (Step S21: 0 in FIG. 7). Following this, the key determination unit 113 terminates the key press judgment processing without carrying out any processing. The key determination unit 113 repeatedly executes the key press judgment processing of Step S9 until a lighting interval elapses. When a lighting interval elapses (Step S10: YES), the lighting control unit 115 turns the backlight 103 off (Step S11). As a result, the touchpad 102 enters a state where the backlight 103 is off as illustrated in portion (a) of FIG. 8.

Subsequently, the key determination unit 113 judges whether none of the keys of the touchpad 102 has a key contact value equal to or greater than the release detection threshold (Step S12). Since, in this example, none of the keys has a key contact value equal to or above the release detection threshold (Step S12: YES), the control processing is terminated, and the processer enters sleep mode.

<A Case where a User Puts his/her Palm in Contact with the Touchpad>

Portion (a) of FIG. 8 illustrates the touchpad 102 where the backlight 103 is off Description is made in the following of an example of the operation of the mobile phone 100 in a case where a user puts his/her palm in contact with the touchpad 102 in such a state, with reference to the flowchart of FIG. 6.

In the following description, it is presumed that, when the user contacts the touchpad 102 with his/her palm, the key contact values of five or more of the keys of the touchpad 102 equal or exceed the multiple key press detection threshold. Additionally, in the following, it is presumed that the processor of the mobile phone 100 is in sleep mode at the start of the description.

Upon receiving input from the touchpad 102, the processor enters intermittent operation mode from sleep mode, and executes a program stored onto the memory. Thus, the key determination unit 113 performs the judgment of whether there is a key having a key contact value equal to or greater than the input interruption detection threshold (Step S1 in FIG. 6). The judgment is performed based on the latest key contact values of each of the keys calculated by the calculation unit 111.

When the key contact values of one or more of the keys which the user has contacted with his/her palm equals or exceeds the input interruption detection threshold (Step S1: YES), the key determination unit 113 subsequently makes a judgment of whether there is a key having a key contact value equal to or greater than the key press detection threshold (Step S2). When the key contact values of one or more of the keys which the user has contacted with his/her palm equals or exceeds the key press detection threshold (Step S2: YES), the key determination unit 113 continuously performs two judgments. The first is the judgment of whether there are five or more keys having key contact values equal to or greater than the multiple key press detection threshold (Step S4). The second is the judgment of whether there is a key (i) which is commonly adjacent to a combination of two of the keys having key contact values equal to or greater than the multiple key press detection threshold, and (ii) which has a key contact value which is smaller than or equal to the release detection threshold (Step S5). Note that the second judgment is performed for all possible combinations of two keys having key contact values equal to or greater than the multiple key press detection threshold. The judgments of Steps S4 and S5 are each performed for every frame interval elapsing. In this example, it is judged that multiple key press has been performed (Step S4: YES), since, by the user contacting the touchpad 102 with his/her palm, the key contact values of five or more of the keys of the touchpad 102 equal or exceed the multiple key press detection threshold. Therefore, the light controlling unit 115 does not turn the backlight 103 on. In consequence, the touchpad 102 is in a state where the backlight 103 remains turned off as illustrated in portion (c) of FIG. 8.

Subsequently, the key determination unit 113 judges whether none of the keys has a key contact value equal to or greater than the release detection threshold (Step S12). When the user's palm is released from the touchpad 102 and when it is judged that none of the keys has a key contact value equal to or above the release detection threshold (Step S12: YES), the control processing is terminated, and the processer returns to sleep mode.

[Modification]

In the following, description is provided on another method for detecting a case where contact made to the touchpad 102 is not a result of a normal user operation performed by the user by using his/her finger or the like. The following method differs from the method according to Step S5 in FIG. 6 and Step S23 in FIG. 7, where such contact is detected by determining that there is a key (i) which is commonly adjacent to a combination of two keys having key contact values equal to or greater than the multiple key press detection threshold, and (ii) which has a key contact value which is smaller than or equal to the release detection threshold.

A mobile phone pertaining to the modification (referred to as a modified mobile phone hereinafter) is obtained by modifying each of the key determination unit 113 and the light controlling unit 115 of the mobile phone 100 so as to provide a slightly different function thereto. Therefore, description is provided hereafter focusing on the differences between the mobile phone 100 and the modified mobile phone.

<Operation>

<Control Processing>

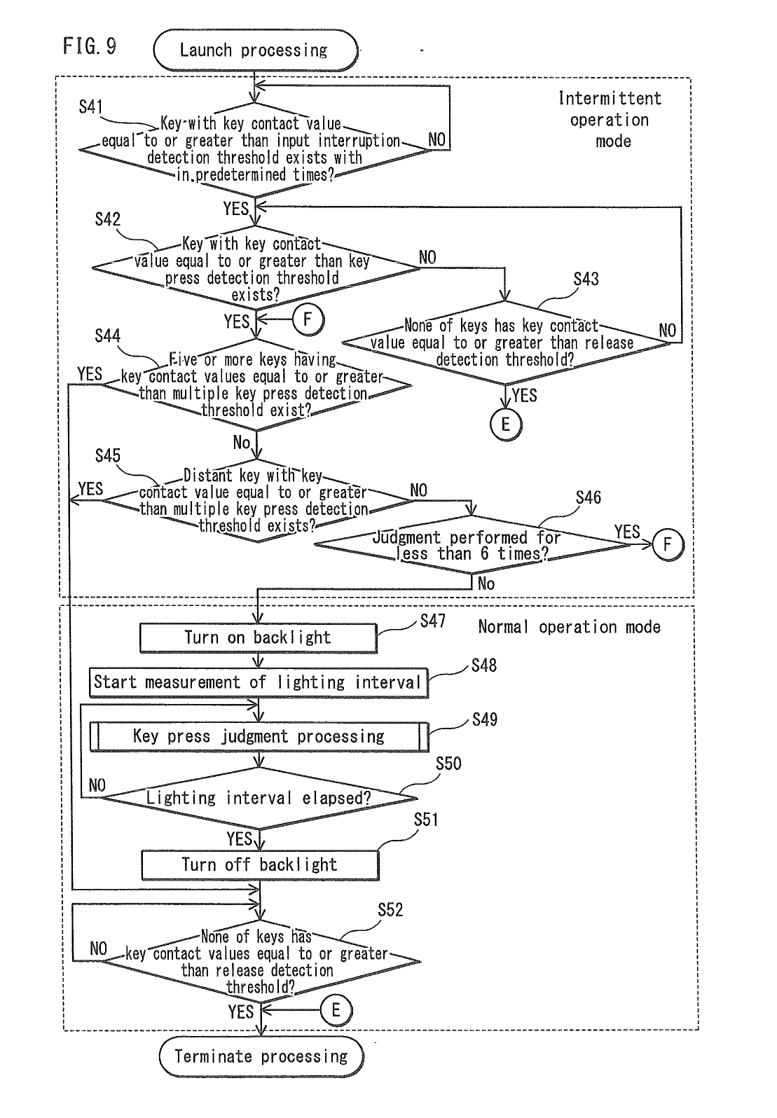

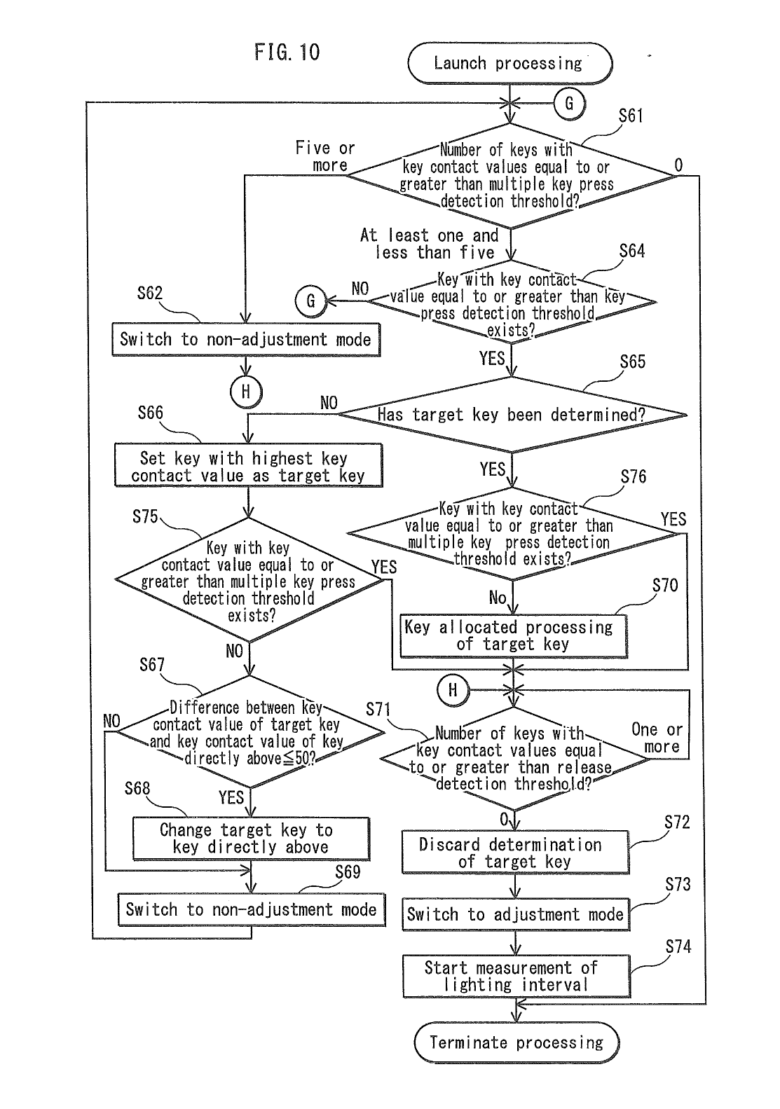

In the following, description is made on the operation of the modified mobile phone, with reference to the accompanying FIGS. 9 and 10.

FIG. 9 is a flowchart illustrating control processing performed by the modified mobile phone in response to input from the touchpad 102.

The control processing of the modified mobile phone illustrated in FIG. 9 differs from the control processing of the mobile phone 100 illustrated in FIG. 6 in that Step S45 is incorporated therein instead of the Step S5.

A lighting control unit of the modified mobile phone (referred to hereinafter as the “modified lighting control unit”) performs a similar processing as performed by the lighting control unit of the mobile phone 100 in Steps S1, S2, and S4 illustrated in FIG. 6. That is, upon receiving input from the touchpad 102, the processor enters intermittent operation mode from sleep mode. Subsequently, the modified lighting control unit judges whether there is a key having a key contact value equal to or greater than the input interruption detection threshold (Step S41). Further, the modified lighting control unit performs a judgment of whether there is a key having a key contact value equal to or greater than the key press detection threshold (Step S42), and a judgment of whether five or more keys have key contact values equal to or greater than the multiple key press detection threshold (Step S44).

In Step S44, when it is judged that less than five keys have key contact values equal to or greater than the multiple key press detection threshold (Step S44: NO), the modified lighting control unit specifies keys (referred to hereinafter as “distant keys”) which are keys of the touchpad 102 excluding (i) keys adjacent to a key having the highest key contact value (referred to hereinafter as “a maximum key”) and (ii) a key which is located two keys below the maximum key in the vertical row, and judges whether one or more of the distant keys have key contact values equal to or greater than the multiple key press detection threshold (Step S45). For instance, when the 5 key is the maximum key, the distant keys are keys of the touchpad 102 excluding keys 1-4, keys 6-9, and the 0 key. Similarly, when the 4 key is the maximum key, the distant keys are keys of the touchpad 102 excluding keys 1, 2, 5, 7, 8, and the * key.

When one or more of the distant keys have key contact values equal to or greater than the multiple key press detection threshold (Step S45: YES), the modified lighting control unit proceeds to the processing of Step S51. This is since, when the user is controlling the keys of the touchpad by using his/her finger or the like, it is presumed that the user is capable of contacting up to four keys at the same time. Under this presumption, there is no possibility of the maximum key and the distant keys being contacted simultaneously. Further, the reason why the key located two keys below the maximum key in the vertical row is not included in the distant keys is because there is a possibility of the finger pad falling into contact with the key located two keys below the maximum key, even in a case where the user is controlling the keys of the touchpad by using his/her finger or the like.

When all of the one or more distant keys have key contact values lower than the multiple key press detection threshold (Step S45: NO), the modified lighting control unit performs the judgment of whether the judgments of Step S44 and S45 have been performed less than a predetermined number of times (6 times, in this example) (Step S46). This is similar to the judgment made in Step S6 in FIG. 6. When the judgments of Steps S44 and S45 have been performed for the predetermined number of times (Step S46: NO), the processor enters normal operation mode from the intermittent operation mode. Further, the lighting control unit 115 causes the backlight 103 to enter lit state (Step S47) and causes the time measuring unit 104 to commence the measurement of lighting interval (Step S48). The Steps S47 and S48 are similar to Steps S7 and S8 in FIG. 6.

Subsequently, the control unit 110 performs the later-described key press judgment processing (refer to FIG. 10) (Step S49), and the modified lighting control unit judges whether a lighting interval has elapsed since the launch of the measurement of lighting interval (Step S50). When a lighting interval has elapsed (Step S50: YES), the modified lighting control unit turns the backlight 103 off (Step S51).

Subsequently, the modified lighting control unit judges whether none of the keys has a key contact value equal to or greater than the release detection threshold (Step S52). Step S52 is similar to the Step S12 in FIG. 6. When it is judged that none of the keys has a key contact value equal to or above the release detection threshold (Step S52: YES), the control processing is terminated, and the processer returns to sleep mode.

<Key Press Judgment Processing>

In the following, description is provided on the key press judgment processing of Step S49.

FIG. 10 is a flowchart illustrating the key press judgment processing (Step S49 in FIG. 9) performed by the modified mobile phone.

The key press judgment processing of the modified mobile phone as illustrated in FIG. 9 differs from the key press judgment processing of the mobile phone 100 in that Step S23 of the control processing of the mobile phone 100 illustrated in FIG. 7 is not included, whereas the processing of Steps S75 and S76 is incorporated.

As illustrated in FIG. 9, the key determination unit of the modified mobile phone (referred to hereinafter as a “modified key determination unit”) determines how many keys have key contact values equal to or greater than the multiple key press detection threshold (Step S61). The determination is performed based on the latest key contact values of each of the keys calculated by the calculation unit 111. Note that this processing is similar to Step S21 in FIG. 7. When it is determined that one to four keys have key contact values equal to or greater than the multiple key press detection threshold (Step S61: at least one and less than five), the modified key determination unit judges whether there is a key having a key contact value equal to or greater than the key press detection threshold among the keys having key contact values higher than the multiple key press detection threshold. The keys having key contact values higher than the multiple key press detection threshold have been determined in Step S61 (Step S64). Note that Step 64 is similar to Step S24 in FIG. 7.

When there is a key having a key contact value equal to or greater than the key press detection threshold (Step S64: YES), the modified key determination unit judges whether a target key has already been determined (Step S65). Note that Step S65 is similar to Step S25 in FIG. 7. When the target key has not yet been determined (Step S65: NO), the modified key determination unit determines the key having the greatest key contact value, among the keys having key contact values equal to or greater than the key press detection threshold, as the target key (Step S66). Note that Step S66 is similar to Step S26 in FIG. 7.

Subsequently, the modified key determination unit judges whether one or more of the keys (referred to hereinafter as “specified keys”) of the touchpad 102 excluding (i) the keys adjacent to the target key and (ii) the key located two keys below the target key in the vertical row, have key contact values equal to or greater than the multiple key press detection threshold (Step S75). For instance, when the 5 key is the target key, the specified keys are keys of the touchpad 102 excluding keys 1-4, keys 6-9, and the 0 key. Similarly, when the 4 key is the target key, the specified keys are keys of the touchpad 102 excluding keys 1, 2, 5, 7, 8, and the * key.

When one or more of the specified keys have key contact values equal to or greater than the multiple key press detection threshold (Step S75: YES), the modified lighting control unit proceeds to the processing of Step S71. The processing proceeds to Step S71 for a similar reason as explained with regards to Step S45 in FIG. 9.

When all of the one or more specified keys have key contact values smaller than the multiple key press detection threshold (Step S75: NO), the modified key determination unit judges whether a value obtained by subtracting, from the key contact value of the target key, a key contact value of a key located directly above the target key is smaller than or equal to a predetermined value (50) (Step S67). The modified key determination unit performs replacement of the target key based on the result of the judgment (Step S68), and the switching unit 112 causes the calculation unit 111 to switch to non-adjustment mode from adjustment mode (Step S69). Subsequently, processing restarts from Step S61.

When it is judged that the target key has been already determined after Steps S61, S64, and S65 have been performed as in the above (Step S65: YES), the modified key determination unit judges whether one or more of the specified keys have key contact values equal to or greater than the multiple key press detection threshold (Step S76). Note that Step S76 is similar to the above-described Step S75.

The judgment of whether one or more of specified keys have key contact values equal to or greater than the multiple key press detection threshold is performed once again in Step S76 since there are cases where contact to the specified keys occurs later than the contact to the target key.

When one or more of the specified keys have key contact values equal to or greater than the multiple key press detection threshold (Step S76: YES), the modified key determination unit proceeds to the processing of Step S71 without carrying out any processing. When all of the one or more specified keys have key contact values smaller than the multiple key press detection threshold (Step S76: NO), the modified key determination unit executes key allocated processing allocated to the target key (Step S70). Note that Step S70 is similar to Steps S30 through S34 in FIG. 7. Subsequently, the modified key determination unit determines the number of keys having key contact values equal to or greater than the release detection threshold (Step S71). When none of the keys has a key contact value equal to or greater than the release detection threshold (Step S71: 0), the modified key determination unit discards the determination of the target key (Step S72), and the switching unit 112 causes the calculation unit 111 to switch to adjustment mode from non-adjustment mode (Step S73). Further, the key determination unit 113 causes the time measuring unit 104 to reset and restart the measurement of lighting interval (Step S74), and thereby terminates the key press judgment processing.

According to the above-described structure of a portable terminal pertaining to the embodiment of the present invention, when detecting contact made to at least one of the areas of the touchpad while the backlight is off, and when the number of areas of the touchpad to which contact has been made at least once equals or exceeds a predetermined number within a first interval from the detection of the contact, the backlight is not turned on.

For example, in a case where the predetermined number is set to a value which is greater than a number of areas of the touchpad to which contact can be normally made by a user's finger, and when the number of areas at which contact is detected exceeds the predetermined number, it can be assumed that the contact has not been made by a user's finger, but by some other means.

Thus, in a case where the predetermined number is set to a value which is greater than a number of areas of the touchpad which can be normally contacted by a user's finger, the portable terminal of the present invention prevents the illumination unit from being turned on by means except a user's finger or the like, and thereby avoids unnecessary consumption of electricity.

[Supplement]

Although description has been made in the above on the portable terminal pertaining to the present invention with focus on an embodiment and a modification thereof (referred to hereinafter simply as “exemplary embodiments”), it is to be understood that the present invention is not limited to the portable terminal as description has been made in the exemplary embodiments, and modifications as introduced below can be made without departing from the spirit and scope thereof.

(1) Although explanation has been made in the above presuming that the mobile phone pertaining to the exemplary embodiments is a flip-type mobile phone which opens in a horizontal direction with respect to the longitudinal direction thereof, the present invention is not limited to this. The mobile phone may be a flip-type mobile phone which opens in a vertical direction with respect to the longitudinal direction thereof, a bar-type mobile phone, a slider-type mobile, or mobile phones having other exterior forms, as long as the mobile phone is equipped with a touchpad.

(2) Although explanation has been made in the above that the mobile phone pertaining to the exemplary embodiments is a mobile phone to which the sub LCD 101 and the touchpad 102 are separately provided as in the illustration of FIG. 3, the present invention is not limited to this. The mobile phone pertaining to the present invention may be provided with the sub LCD 101 and the touchpad 102 in an integrated state. That is, the mobile phone may include a so-called touch panel.

Further, in providing such a touch panel to the mobile phone pertaining to the present invention, the touch panel need not be embodied as a single touch panel having both a controller part for receiving user operations and a display part for displaying characters and the like resulting from the user operations. That is, the touch panel may be provided solely for receiving input of numbers, characters and the like from the user, and the display part for displaying input characters and the like may be separately embodied as an LCD, an organic light-emitting diode (Organic Electro-Luminescence) or the like.

Additionally, the touch panel need not be realized by using a display device such as an LCD for displaying images and the like. In other words, the touch panel need not display characters and the like. Alternatively, the touch panel may be embodied as a combination of an illumination unit and a sheet disposed above the illumination unit which has transmissive portions formed in the shape of characters and marks. In such a case, the user may, for example, press areas of the sheet corresponding to transmissive portions on which the shapes of predetermined characters have been formed, thereby bringing about a change in the electrostatic capacity of the touchpad. Thus, the predetermined character on the sheet is input to the touchpad.

(3) In the above, it has been explained that the touchpad 102 pertaining to the exemplary embodiments of the present invention is realized with use of a capacitive touch sensor. As such a capacitive touch sensor for realizing the touchpad 102, an appropriate type is to be selected from various types of capacitive touch sensors. Types of touch sensors include: a projected capacitance touch sensor which includes multiple electrode patterns formed on a substrate composed of plastic, glass or the like and which can detect contact made to locations thereof by measuring ratios of amperages between different electrode patterns in the vicinity of the contact location; a surface capacitance touch sensor which includes a conductive layer, a substrate, and electrodes provided to the edges of the substrate, in which a uniform electrostatic field is formed by the conductive layer, and the contact location is detected by measuring a ratio between the amperages of the electrodes caused by the contact made thereto by a finger or the like. Further, with regards to the touch panel as explanation has been made in (2) above, an appropriate touch panel may be similarly selected as necessary from various types of touch panels.

Further, although explanation has been provided in the exemplary embodiments that the touchpad 102 is embodied by use of a capacitive touch sensor, the present invention is not limited to this. Alternatively, the touchpad 102 may be embodied as: an electromagnetic induction touch sensor, a matrix switch touch sensor, a resistive touch sensor, a surface acoustic wave touch sensor, an infrared touch sensor, an optical sensor touch sensor or the like. In further explanation of each of the types of the touch sensors, an electromagnetic induction touch sensor requires the use of a special pen such as an electronic pen, a matrix switch touch sensor is composed of transparent electrodes having two-layer structures, a resistive touch sensor includes two resistive layers and voltage is applied to one resistive layer and the other resistive layer detects changes in voltage according to locations on the one resistive layer to which contact has been made, a surface acoustic wave touch sensor detects contact made by a finger or the like by detecting the reflection of ultrasonic waves by monitoring the voltage changes of piezoelectric elements, an infrared touch sensor detects a location thereof to which contact has been made by a finger or the like by using shielded infrared beams, and an optical sensor touch sensor detects a location thereof to which contact has been made by using an optical sensor provided to the screen.

(4) In the exemplary embodiments, the value of the GND, the value of the release detection threshold, the value of the multiple key press detection threshold, and the value of the key press detection threshold are set to “512”, “580”, “580”, and “632”, respectively. However, such values have been provided for the mere sake of examples, and desirably, such values are to be determined as in the following.

As description has already been made in the above, a key contact value is calculated based on the electrostatic capacity value which is output from the touchpad 102. Therefore, it is preferable that the GND value be determined based on a preemptively-measured value indicating electrostatic capacity output from the touchpad 102 in a state where objects such as a user's finger is not in contact therewith.

Further, the electrostatic capacity value output from the touchpad 102 is subject to change even when contact is not actually being made to the touchpad 102. That is, there are cases where the electrostatic capacity value fluctuates due to noises being generated. The generation of such noises occurs by units of the mobile phone undergoing operation to perform functions allocated thereto. Such functions of the mobile phone include a telephone function, a camera function and the like. Accordingly, it is preferable that the release detection threshold and the multiple key press detection threshold be determined by performing a preemptive measurement of the extent to which the electrostatic capacity value output from the touchpad 102 increases during the operation of such functions, and by setting the thresholds based on the result of the measurement.

Additionally, when contact is made to a key by a user's finger or the like, not only the key contact value of the contacted key changes but also the key contact values of keys which are adjacent to the contacted key but which have not actually been contacted are subject to change. In the embodiment, the difference between the value (580) of the release detection threshold and the multiple key press detection threshold, and the value (632) of the key press detection threshold is fixed to “52”. However, the present invention is not limited to this, and it is desirable that the difference between the threshold values be determined based on a result of a preemptive measurement of the extent to which each of the electrostatic capacity value of the key to which contact is actually made and the electrostatic capacity value of the keys which are adjacent to the contacted key but which have not actually been contacted increases. It is preferable that the release detection threshold and the multiple key press detection threshold be determined based on the difference determined as such.

In addition, the release detection threshold and the multiple key press detection threshold are provided with a same value (580) in the exemplary embodiments. However, the two thresholds need not be provided with a same value, and the values of the release detection threshold and the multiple key press detection threshold may be set individually.

(5) In the exemplary embodiments, description is made under the presumption that, when the user makes key operations on the touchpad 102 by using his/her finger or the like, the maximum number of keys which may be simultaneously contacted is four. Hence, description has been made that multiple key press is detected when five or more keys are contacted. However, this is merely one example, and configuration may be made such that multiple key press is detected when a predetermined number of keys are contacted, provided that the predetermined number is set to two or more. Further, when the user makes key operations to the touchpad using his/her finger or the like, the maximum number of keys which can be simultaneously contacted may vary to a certain extent according to such reasons as the size of the user's finger or the like. Thus, configuration may be made such that multiple key press is detected when a predetermined number of keys are contacted simultaneously, the predetermined number of keys being set by having the user actually perform key operations at the beginning of the use of the mobile phone pertaining to the exemplary embodiments, and counting the maximum number of keys simultaneously contacted by the user. In addition, configuration may be also made such that the user is able to set the number of keys where multiple key press is to be detected.

(6) In Step S22 in FIG. 7 and Step S62 in FIG. 10, the state of the calculation unit 111 is caused to switch from adjustment mode to non-adjustment mode so that the determination of the subsequent target key can be performed as quickly as possible. More specifically, such prompt determination of the subsequent target key is made possible by the key contact values of the each of the keys quickly falling below the key press detection threshold when contact to the touchpad 102 has been released. However, the present invention is not limited to this, and the switching of the calculation unit from the adjustment mode to the non-adjustment mode need not be performed.

This is since, when Step S22 in FIG. 7 is executed, it can be assumed that contact is being made to the touchpad 102 by a user's body part besides his/her finger, or an object which is disposed in a user's bag along with the portable terminal pertaining to the exemplary embodiments, rather than by a user's finger or the like as in a normal user operation. In such cases, the necessity of realizing prompt execution of processing in response to subsequent key operation is comparatively low.

In addition, the processing of Step S22 in FIG. 7 and Step S62 in FIG. 10 may be executed only when the calculation unit 111 is in adjustment mode.

(7) In Step S27 in FIG. 7 and Step S67 in FIG. 10, the judgment is made of whether the difference between the key contact value of the target key (a key having the highest key contact value) and the key contact value of the key directly above the target key is smaller than or equal to a predetermined value (50, in this example). However, the present invention is not limited to this, and, the same judgment may be performed using the key contact values of the keys located directly to the left and directly to the right of the target key, in addition to the key contact value of the key directly above the target key. In such a case, a calculation is to be performed for each of the key directly above the target key, the key directly to the right of the target key, and the key directly to the left of the target key, to obtain the difference between the key contact values of the target key and each of such keys. Subsequently, when at least one of the calculated differences is smaller than or equal to the predetermined value, the target key may be determined as the key having a key contact value the difference between which and the key contact value of the previous target key being the smallest.

In addition, the difference may be calculated between the key contact value of the target key and the key contact value of either one of the key directly to the left of the target key and the key directly to the right of the target key. Further, configuration may be also made such that the user is able to select the key used for the calculation of the difference from the key directly above the target key, the key directly to the left of the target key, and the key directly to the right of the target key.

(8) Further, in Step S27 in FIG. 7 and Step S67 in FIG. 10, judgment is made of whether the difference between the key contact value of the target key (a key having the highest key contact value) and the key contact value of the key directly above the target key is smaller than or equal to a predetermined value (50, in this example). However, the present invention is not limited to this, and instead, a judgment may be performed of whether the key contact value of the key directly above the target key is equal to or greater than a predetermined value which is set higher in value than the key press detection threshold. As description has been made in (7) above, a similar configuration may be made even in cases where the calculation of difference is performed using the key directly to the right of the target key and/or the key directly to the left of the target key.

It is preferable that the predetermined value which is set higher than the key press detection threshold as description has been made in the above be determined, for example, by having the user actually perform operations for several times on the portable terminal. Accordingly, the predetermined value may be determined based on the results yielded.

(9) Description has made in the above that the mobile phone pertaining to the exemplary embodiments performs the judgment (the judgments of Step S4 in FIG. 6, Step S44 in FIG. 9, Step S5 in FIG. 6, or Step S45 in FIG. 9) of whether contact is being made to the touchpad 102 by operations besides normal key operations performed by a user's finger or the like six times, or that is, for six frame intervals at the most. Such a judgment is performed under the condition that the backlight 103 of the mobile phone is off, and that there is at least one key having a key contact value equal to or greater than the key press detection threshold.

However, this is merely one example of the number of times such a judgment may be performed, and the judgment may be performed for more or less than 6 times, provided that the judgment is performed at least once.

(10) In the exemplary embodiments, description has been made of an example where only one lighting interval is used. However, the present invention is not limited to this, and the lighting interval whose measurement is launched in Step S8 in FIG. 6 or Step S48 in FIG. 9, and the lighting interval whose measurement is launched in Step S34 of FIG. 7 or Step S74 in FIG. 19 may be different intervals of time.

In addition, the lighting interval may be changed according to the number of times Step S34 in FIG. 7 or Step 74 in FIG. 10 has been performed since the launch of the control processing of FIG. 6.

(11) In the exemplary embodiments, although description is made that the backlight 103 for illuminating the touchpad 102 is included in the touchpad 102, the present invention is not limited to this. For instance, the backlight 103 need not be stacked on the touchpad 102 in the thickness direction of the housing of the mobile phone, and alternatively, the backlight 103 may be disposed at a position where the backlight 103 does not overlap with the touchpad 102 in the thickness direction of the housing.

(12) In the exemplary embodiments, description is made that the touchpad 102 sends, to the control unit 110, at least one pair of values consisting of a coordinate value (x, y) of the contacted position and an electrostatic capacity value of the contacted position, and the calculation unit 111 calculates a key contact value for each of the keys based on the at least one pair of values. However, modification may be made as described in the following.

That is, a touchpad pertaining to this modification (referred to as a “modified touchpad” hereinafter) may be configured to output, for each of the keys, a value which increases/decreases according to the size of the contacted area within a coordinate area corresponding to a key. Further, the calculation unit pertaining to this modification (referred to as a “modified calculation unit” hereinafter) may calculate a key contact value for each of the keys of the touchpad 102 according to the mode thereof (adjustment mode or non-adjustment mode).

More specifically, in such a modification, the twenty ports of the capacitive touch sensor IC (Integrated Circuit) for realizing the modified touchpad are allocated in one-to-one correspondence to the keys of the modified touchpad. A value which increases/decreases between 0-1024 according to the contacted area within the coordinate area corresponding to a key is input, for each of the keys, to the modified calculation unit via each of the ports. Further, the number of ports provided to the IC is not limited to twenty as provided in the above example, and may be changed as necessary.

(13) Further, the components on which explanation has been made in the exemplary embodiments may be partially or entirely embodied as an integrated circuit having one chip or multiple chips. Further, the components may also be embodied as a computer program or as any type of embodiment.

Further, the components explanation of which has been made in the exemplary embodiments operate in a cooperative manner with the processor included in the mobile phone, and thus, realize the functions provided thereto.

(14) It may be conceived to distribute a program for causing a CPU (Central Processing Unit) to execute the operations to be performed in response to input from the touchpad 102 (refer to FIGS. 6, 7, 9, and 10) as explanation has been made in the exemplary embodiments. The distribution of such a program may be realized by recording the program onto recording media, or transmitting the program via various communication paths. The recording media which may be used in such distribution of the program include IC cards, optical discs, flexible disks, ROMs, flash memories, and the like. The distributed program is to be stored to a memory or the like which may be read by the CPU provided to devices, so that the CPU may access and execute the program. Thereby, each of the functions of each of the mobile phones description has been made on in the exemplary embodiments is to be realized.

(15) In the following, description is provided on a structure of a portable terminal pertaining to one embodiment of the present invention as well as on modifications thereof. Additionally, description is made on the advantageous effects of such portable terminals.

(a) One aspect of the present invention is a portable terminal comprising: a touchpad having a plurality of areas; an illumination unit configured to illuminate the touchpad when in a lit state, and not to illuminate the touchpad when in an unlit state; and a control unit configured to detect contact made to each of the areas of the touchpad, to perform a first judgment when detecting contact made to at least one of the areas of the touchpad during the unlit state of the illumination unit, the first judgment being a judgment of whether or not the number of areas of the touchpad to which the contact during the unlit state of the illumination unit has been made equals or exceeds a predetermined number within a first interval from the detection of the contact during the unlit state of the illumination unit, and to cause the illumination unit to enter the lit state when the result of the first judgment is negative and not to cause the illumination unit to enter the lit state when the result of the first judgment is positive.

A second aspect of the present invention is a control program used in a portable terminal, the portable terminal including a touchpad and an illumination unit that illuminates the touchpad when in a lit state and that does not illuminate the touchpad when in an unlit state, the control program comprising: a controlling step of detecting contact made to each of the areas of the touchpad, performing a first judgment when detecting contact made to at least one of the areas of the touchpad during the unlit state of the illumination unit, the first judgment being a judgment of whether or not the number of areas of the touchpad to which the contact during the unlit state of the illumination unit has been made equals or exceeds a predetermined number within a first interval from the detection of the contact during the unlit state of the illumination unit, and causing the illumination unit to enter the lit state when the result of the first judgment is negative and not causing the illumination unit to enter the lit state when the result of the first judgment is positive.

A third aspect of the present invention is a control method used in a portable terminal, the portable terminal including a touchpad and an illumination unit that illuminates the touchpad when in a lit state and that does not illuminate the touchpad when in an unlit state, the control method comprising: a controlling step of detecting contact made to each of the areas of the touchpad, performing a first judgment when detecting contact made to at least one of the areas of the touchpad during the unlit state of the illumination unit, the first judgment being a judgment of whether or not the number of areas of the touchpad to which the contact during the unlit state of the illumination unit has been made equals or exceeds a predetermined number within a first interval from the detection of the contact during the unlit state of the illumination unit, and causing the illumination unit to enter the lit state when the result of the first judgment is negative and not causing the illumination unit to enter the lit state when the result of the first judgment is positive.

According to the above structure of the portable terminal pertaining to one embodiment of the present embodiment, when detecting contact made to at least one of the areas of the touchpad during the unlit state of the illumination unit, and when the number of areas of the touchpad to which contact has been made at least once within the first interval equals or exceeds the predetermined number, the illumination unit remains in the unlit state.

For example, when the predetermined number is set to a value which is greater than a number of areas of the touchpad to which contact can be normally made by a user's finger, and when the number of areas at which contact is detected exceeds the predetermined number, it can be assumed that the contact has not been made by a user's finger, but by some other means.

Hence, the portable terminal of the present invention prevents the illumination unit from being lighted by means other than a user's finger or the like, and thereby avoids unnecessary consumption of electricity when the predetermined number is set to a value which is greater than a number of areas of the touchpad which can be normally contacted by a user's finger.

(b) Further, it is preferable that the control unit of the portable terminal be further configured to perform a second judgment when the result of the first judgment is negative, the second judgment being a judgment of whether contact has been made to at least one of the areas of the touchpad within a second interval from the entering of the illumination unit to the lit state, and to cause the illumination unit to enter the unlit state when the result of the second judgment is negative and not to cause the illumination unit to enter the unlit state when the result of the second judgment is positive.

Hence, even in cases where the illumination unit has entered the lit state, the portable terminal causes the illumination unit to enter the unlit state when no contact is made to the touchpad during a second interval from the entering of the illumination unit to the lit state. As such, the portable terminal of the present invention reduces the risk of electricity being consumed as a result of the illumination unit remaining in the lit state.

(c) In addition, it is preferable that the control unit of the portable terminal be further configured to perform a third judgment when the result of the second judgment is positive, the third judgment being a judgment of whether contact has been made to at least one of the areas of the touchpad within a third interval from release of the contact made during the second interval, and to cause the illumination unit to enter the unlit state when the result of the third judgment is negative and not to cause the illumination unit to enter the unlit state when the result of the third judgment is positive.

Hence, the portable terminal of the present invention causes the illumination unit to enter the unlit state in a case where, although contact has been made during the second interval, no contact is made to the touchpad within a third interval from the release of the contact made during the second interval. As such, the portable terminal of the present invention reduces the risk of electricity being consumed as a result of the illumination unit remaining in the lit state.

(d) Also, it is preferable that the portable terminal be modified such that the touchpad is further configured to output at least one value that indicates a degree of contact made thereto, the portable terminal further comprises: a calculation unit configured to perform management of each of the areas of the touch pad and calculate, for each of the areas of the touchpad to which contact has been made, a value indicating a degree of contact made according to the at least one value output from the touchpad; and a holding unit configured to hold a first threshold and a second threshold, the first threshold being used by the control unit in the detection of contact made to the areas of the touchpad, and the second threshold being smaller than the first threshold, and the control unit detects the contact during the unlit state of the illumination unit when at least one of the values calculated by the calculation unit equals or exceeds the first threshold, performs the first judgment by using the second threshold, and judges positively in the first judgment only when the number of values equaling or exceeding the second threshold, among the values calculated by the calculating unit, equals or exceeds the predetermined number within the first interval.

Hence, the portable terminal of the present invention does not cause the illumination unit to enter the lit state when the number of areas whose values calculated by the calculation unit equal or exceed the second threshold equals or exceeds the predetermined number within a the first interval from when it is detected that an area exists whose value calculated by the calculation unit equals or exceeds the first threshold.

Hence, the entering of the illumination unit to the lit state is prevented even in a case where a same number of, or more than a predetermined number of areas are found having values indicating degree of contact, the values thereof being lower than the first detection threshold used to detect the number of areas to which contact has been made. As such, the portable terminal of the present invention reduces the risk of electricity being consumed as a result of the illumination unit being lit in such a case.

(e) Further, it is preferable that the control unit of the portable terminal be further configured to perform a third judgment when detecting the contact during the unlit state of the illumination unit, the third judgment being a judgment of whether or not two areas of the touchpad fulfill given conditions within the first interval, the conditions being: (i) two values calculated by the calculation unit corresponding to the two areas equal or exceed the second threshold; and (ii) the two areas are not adjacent to each other, and to cause the illumination unit to enter the lit state only when the result of the third judgment is negative.

Hence, the portable terminal of the present invention does not cause the illumination unit to enter the lit state when it is judged that there has existed, at least once, two areas which fulfill the two conditions of (i) two values calculated by the calculation unit corresponding to the two areas equal or exceed the second threshold, and (ii) the two areas are not adjacent to each other, within a the first interval from when it is detected that an area exists whose value calculated by the calculation unit equals or exceeds the first threshold.

For instance, it can be assumed that something other than the user's finger or the like has contacted the touchpad when, under a condition where the size and the location of each of the areas of the touchpad are determined such that the user cannot contact two adjacent areas at the same time during normal user operation, it is judged that there has existed, at least once, two areas which fulfill the two conditions of (i) two values calculated by the calculation unit corresponding to the two areas equal or exceed the second threshold, and (ii) the two areas are not adjacent to each other.

Thus, the portable terminal of the present invention does not cause the illumination to enter the lit state when something other than a user's finger or the like contacts the touchpad under the condition where the size and the location of each of the areas of the touchpad are determined such that the user cannot contact two adjacent areas at the same time during normal user operation. As such, the portable terminal of the present invention reduces the risk of electricity being consumed as a result of the illumination unit being lit in such a manner.

(f) It is also preferable that the illumination unit of the portable terminal is a backlight that is provided to the touchpad.

Hence, the portable terminal of the present invention prevents the backlight from entering the lit state when the touchpad is contacted by something other than a user's finger or the like, in a case where the predetermined number is determined as a number having a greater value than the number of areas to which a user's finger or the like can make contact to at the same time. As such, the portable terminal of the present invention reduces the risk of electricity being consumed as a result of the backlight being lit in such a manner.

(16) The touchpad and lighting unit pertaining to the present invention each correspond to the touchpad 102 and the backlight 103 pertaining to the exemplary embodiments, the control unit pertaining to the present invention corresponds to the lighting control unit 115 pertaining to the exemplary embodiments, and the combination of the calculation unit and the holding unit pertaining to the present invention corresponds to the calculation unit 111 pertaining to the exemplary embodiments.

(17) The present invention may be a method for use in mobile phones, as well as a computer program for realizing such a method with the use of a computer.

### INDUSTRIAL APPLICABILITY

The mobile phone pertaining to the present invention is used by a user when making operations on a touchpad.

### REFERENCE SIGNS LIST

1, 2 housings
3 input keys
4 LCD
100 mobile phone
101 sub LCD
102 touchpad
103 backlight
104 time measuring unit
105 speaker
106 microphone
107 vibrator
108 communication unit
110 control unit
111 calculation unit
112 switching unit
113 key determination unit
114 event notification unit
115 lighting control unit
116 audio processing unit
117 display control unit
120 application execution unit

1. A portable terminal comprising:
a touchpad having a plurality of areas;
an illumination unit configured to illuminate the touchpad when in a lit state, and not to illuminate the touchpad when in an unlit state; and
a control unit configured to detect contact made to each of the areas of the touchpad, to perform a first judgment when detecting contact made to at least one of the areas of the touchpad during the unlit state of the illumination unit, the first judgment being a judgment of whether or not the number of areas of the touchpad to which the contact during the unlit state of the illumination unit has been made equals or exceeds a predetermined number within a first interval from the detection of the contact during the unlit state of the illumination unit, and to cause the illumination unit to enter the lit state when the result of the first judgment is negative and not to cause the illumination unit to enter the lit state when the result of the first judgment is positive.

2. The portable terminal of claim 1, wherein
the control unit is further configured to perform a second judgment when the result of the first judgment is negative, the second judgment being a judgment of whether contact has been made to at least one of the areas of the touchpad within a second interval from the entering of the illumination unit to the lit state, and to cause the illumination unit to enter the unlit state when the result of the second judgment is negative and not to cause the illumination unit to enter the unlit state when the result of the second judgment is positive.

3. The portable terminal of claim 2, wherein
the control unit is further configured to perform a third judgment when the result of the second judgment is positive, the third judgment being a judgment of whether contact has been made to at least one of the areas of the touchpad within a third interval from release of the contact made during the second interval, and to cause the illumination unit to enter the unlit state when the result of the third judgment is negative and not to cause the illumination unit to enter the unlit state when the result of the third judgment is positive.

4. The portable terminal of claim 1, wherein
the touchpad is further configured to output at least one value that indicates a degree of contact made thereto,
the portable terminal further comprises:
a calculation unit configured to perform management of each of the areas of the touch pad and calculate, for each of the areas of the touchpad to which contact has been made, a value indicating a degree of contact made according to the at least one value output from the touchpad; and
a holding unit configured to hold a first threshold and a second threshold, the first threshold being used by the control unit in the detection of contact made to the areas of the touchpad, and the second threshold being smaller than the first threshold, and
the control unit detects the contact during the unlit state of the illumination unit when at least one of the values calculated by the calculation unit equals or exceeds the first threshold, performs the first judgment by using the second threshold, and judges positively in the first judgment only when the number of values equaling or exceeding the second threshold, among the values calculated by the calculating unit, equals or exceeds the predetermined number within the first interval.

5. The portable terminal of claim 4, wherein
the control unit is further configured to perforin a third judgment when detecting the contact during the unlit state of the illumination unit, the third judgment being a judgment of whether or not two areas of the touchpad fulfill given conditions within the first interval, the conditions being: (i) two values calculated by the calculation unit corresponding to the two areas equal or exceed the second threshold; and (ii) the two areas are not adjacent to each other, and to cause the illumination unit to enter the lit state only when the result of the third judgment is negative.

6. The portable terminal of claim 1, wherein
the illumination unit is a backlight that is provided to the touchpad.

7. A control program used in a portable terminal, the portable terminal including a touchpad and an illumination unit that illuminates the touchpad when in a lit state and that does not illuminate the touchpad when in an unlit state, the control program comprising:
a controlling step of detecting contact made to each of the areas of the touchpad, performing a first judgment when detecting contact made to at least one of the areas of the touchpad during the unlit state of the illumination unit, the first judgment being a judgment of whether or not the number of areas of the touchpad to which the contact during the unlit state of the illumination unit has been made equals or exceeds a predetermined number within a first interval from the detection of the contact during the unlit state of the illumination unit, and causing the illumination unit to enter the lit state when the result of the first judgment is negative and not causing the illumination unit to enter the lit state when the result of the first judgment is positive.

8. A control method used in a portable terminal, the portable terminal including a touchpad and an illumination unit that illuminates the touchpad when in a lit state and that does not illuminate the touchpad when in an unlit state, the control method comprising:
a controlling step of detecting contact made to each of the areas of the touchpad, performing a first judgment when detecting contact made to at least one of the areas of the touchpad during the unlit state of the illumination unit, the first judgment being a judgment of whether or not the number of areas of the touchpad to which the contact during the unlit state of the illumination unit has been made equals or exceeds a predetermined number within a first interval from the detection of the contact during the unlit state of the illumination unit, and causing the illumination unit to enter the lit state when the result of the first judgment is negative and not causing the illumination unit to enter the lit state when the result of the first judgment is positive.
